(19) United States
(12) Patent Application Publication
(10) Pub. No.: US 2025/0199823 A1
(43) Pub. Date: Jun. 19, 2025

(54) NOTIFICATION SYSTEM FOR DISTRIBUTED APPLICATIONS

(71) Applicant: VMware LLC, Palo Alto, CA (US)

(72) Inventors: Shuying Yan, Beijing (CN); Qiang Wan, Beijing (CN); Ming Liu, Beijing (CN); Lifeng Dong, Beijing (CN)

(73) Assignee: VMware LLC, Palo Alto, CA (US)

(21) Appl. No.: 17/290,631

(22) Filed: Apr. 30, 2021

(30) Foreign Application Priority Data
Jan. 19, 2021 (WO) PCT/CN2021/072613

(51) Int. Cl. G06F 9/451; G06F 9/445; G06F 16/36; G06F 40/30

(52) U.S. Cl. CPC G06F 9/451; G06F 9/44526; G06F 16/367; G06F 40/30

(57) ABSTRACT

The current document is directed to an improved notification system for distributed applications. The new and improved notification system provides a notification-customization interface and a notification dashboard, accessible to users of the notification system through commonly available web browsers. The customization interface allows users to specify the types of notifications which the user desires, to specify the information to be included in the notifications, to specify the user devices to which notifications are to be transmitted, and to specify time ranges and/or relative times for notification transmission. The notification dashboard provides a dashboard interface for receiving, storing, and accessing stored notifications accessible to Internet-connected devices. In described implementations, the notification system employs an ontology to provide a common language for notification specification.

### CROSS-REFERENCE TO RELATED APPLICATION

This application claims priority to PCT Application PCT/CN2021/072613, filed Jan. 19, 2021.

### TECHNICAL FIELD

The current document is directed to distributed-computer-systems and, in particular, to an improved notification system for distributed-computer-systems.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking. distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, distributed-system management, and distribute-application management. As new distributed-computing technologies are developed, and as general hardware and software technologies continue to advance, the current trend towards ever-larger and more complex distributed computing systems appears likely to continue well into the future.

For many different types of distributed applications. many administrative and management personnel desire to receive notifications of various types of events and distributed-application state changes that occur during operation of a distributed application within a distributed computer system. System managers, for example, may wish to be notified of the occurrence of various types of errors and warning conditions. Developers may wish to be notified of applications released by automated continuous-development distributed pipeline applications. Automated notification can be built into distributed applications, but currently available notification technologies and subsystems are associated with numerous deficiencies, as further discussed below. Developers, administrators, and users of distributed applications therefore continue to seek improved notification systems without the deficiencies of currently available notification systems.

### SUMMARY

The current document is directed to an improved notification system for distributed applications. The new and improved notification system provides a notification-customization interface and a notification dashboard, accessible to users of the notification system through commonly available web browsers. The customization interface allows users to specify the types of notifications which the user desires, to specify the information to be included in the notifications, to specify the user devices to which notifications are to be transmitted, and to specify time ranges and/or relative times for notification transmission. The notification dashboard provides a dashboard interface for receiving, storing, and accessing stored notifications accessible to Internet-connected devices. In described implementations, the notification system employs an ontology to provide a common language for notification specification.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server,

components of a distributed system that provides multi-cloud aggregation and that includes a cloud-connector server and cloud-connector nodes that cooperate to provide services that are distributed across multiple clouds.

FIGS. 11A-B illustrate an example distributed pipeline application referred to as “VMware Code Stream.”

FIG. 12 provides a generalized illustration of a distributed pipeline application.

FIGS. 13A-E illustrate traditional notifications provided by a distributed pipeline application and various problems and deficiencies associated with traditional notifications.

FIG. 14 illustrates an approach taken to improve notification by distributed pipeline applications and other types of distributed applications that is disclosed in the current document and claimed in the current claims.

FIG. 15 illustrates the new and improved notification system disclosed in the current document.

FIG. 16 illustrates a plug-in.

FIG. 17 illustrates an ontology used by the currently disclosed new and improved notification system.

FIGS. 18A-D illustrate a simple example of how the currently disclosed new and improved notification system uses an ontology for obtaining customized, user-specified notifications and to implement the customized, user-specified notifications.

FIGS. 19A-F provide an overview of a family of graph data-modeling vocabularies that can be used to implement the currently disclosed notification system.

FIGS. 20A-C illustrate use of regular expressions.

FIGS. 21A-C illustrate semantic-similarity-based machine-reading-comprehension (“MRC”) systems.

FIG. 22 shows a block diagram for one implementation of the currently disclosed new and improved notification system.

FIGS. 23A-F provide control-flow diagrams that illustrate implementation and operation of the components of the currently disclosed notification system. introduced above with reference to FIG. 22.

### DETAILED DESCRIPTION

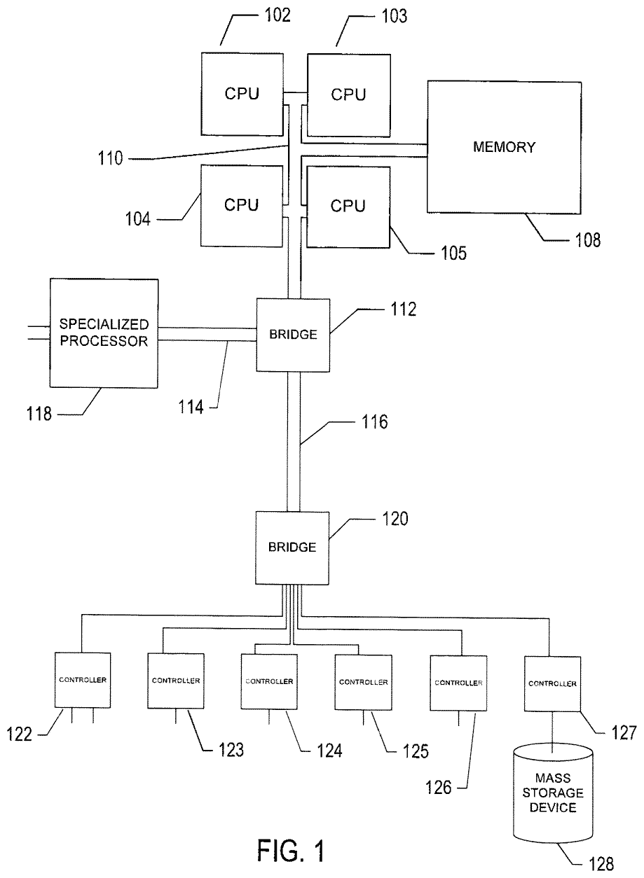

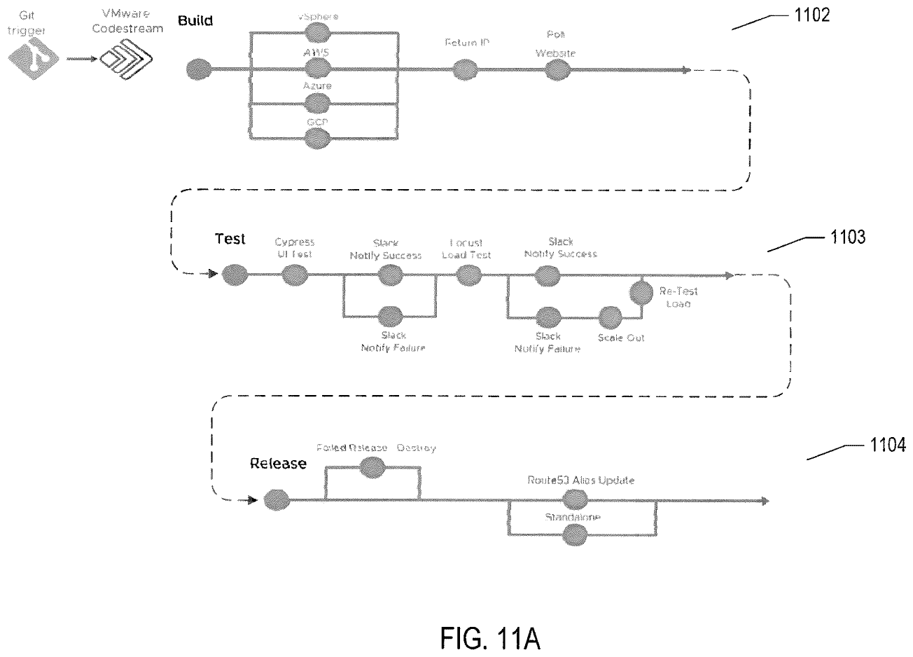

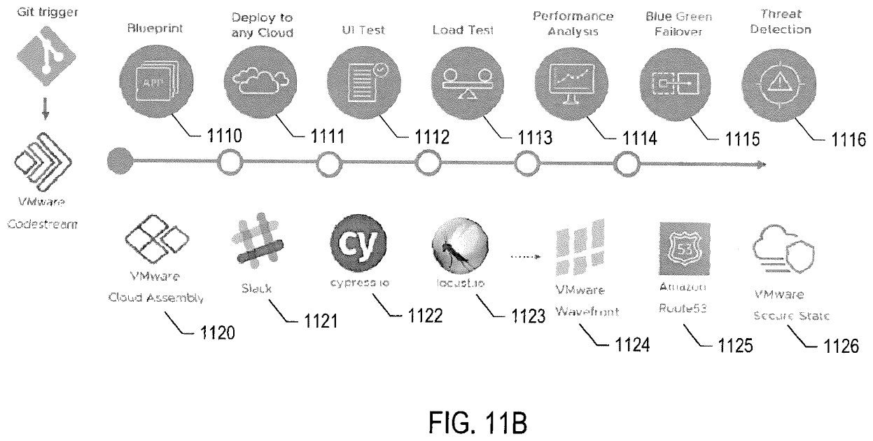

The current document is directed to a new and improved notification system for distributed applications. In a first subsection, below, a detailed description of computer hardware, complex computational systems, and virtualization is provided with reference to FIGS. 1-10. The currently disclosed notification system is discussed with reference to FIGS. 11A-23F in a second subsection.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices. no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

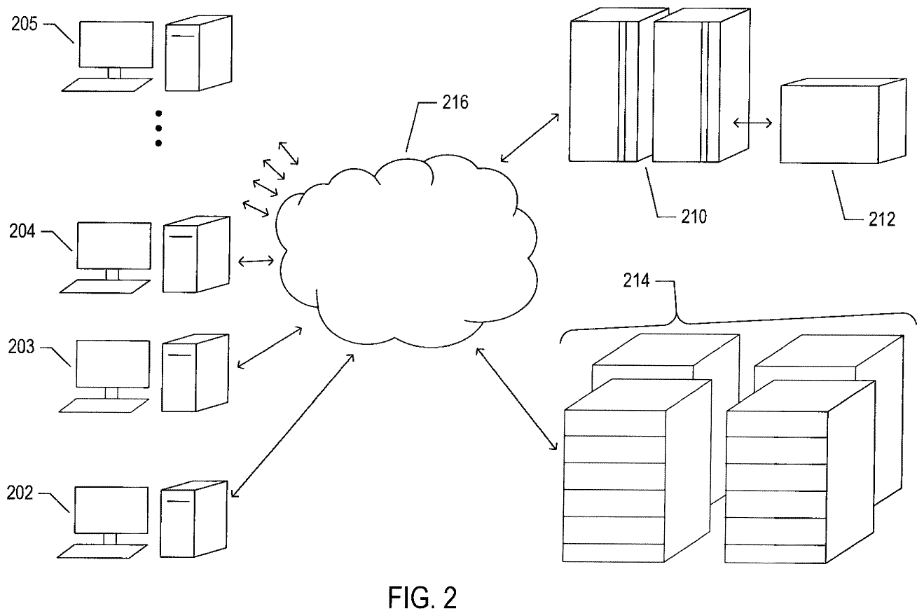

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

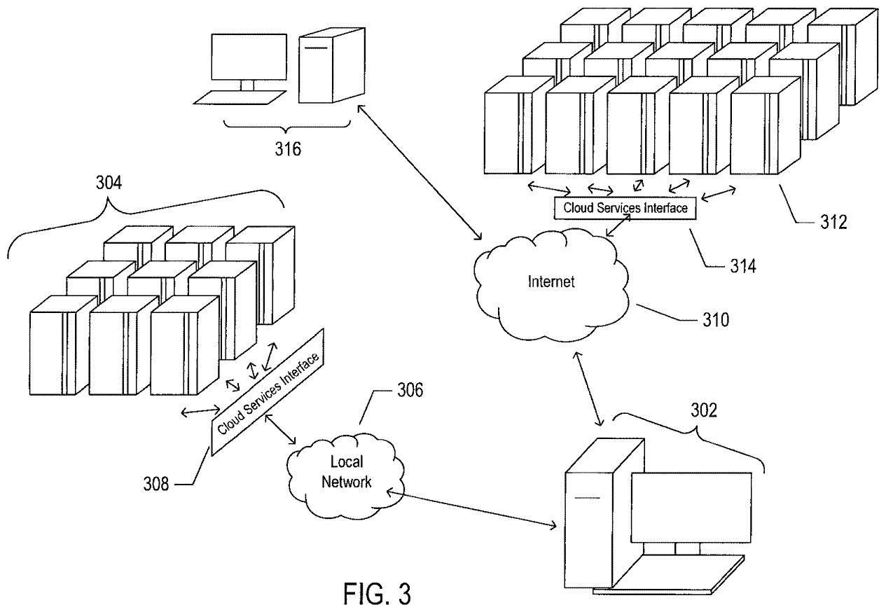

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

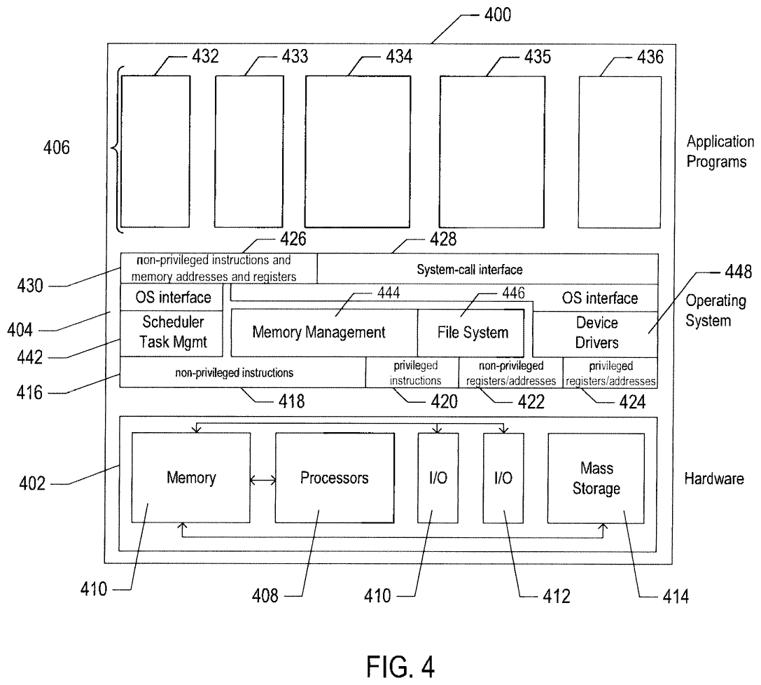

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and workload-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

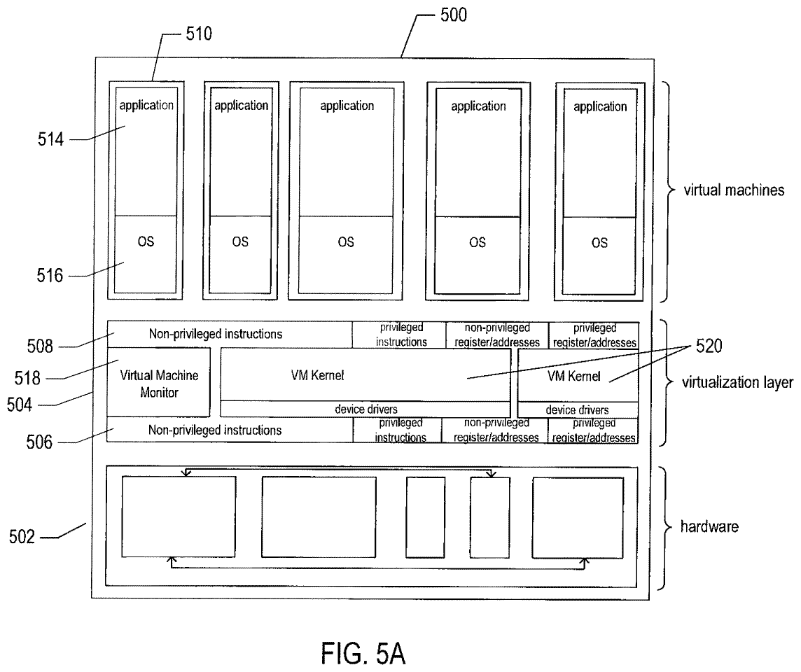

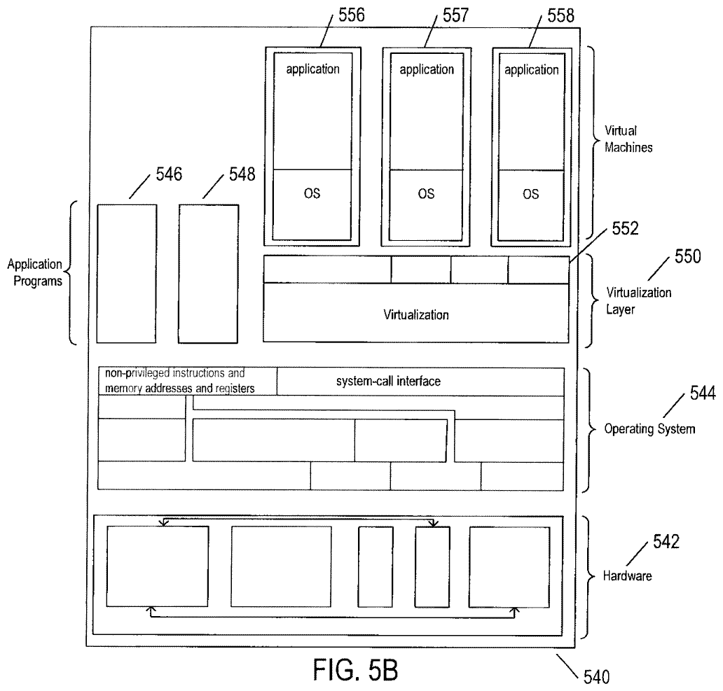

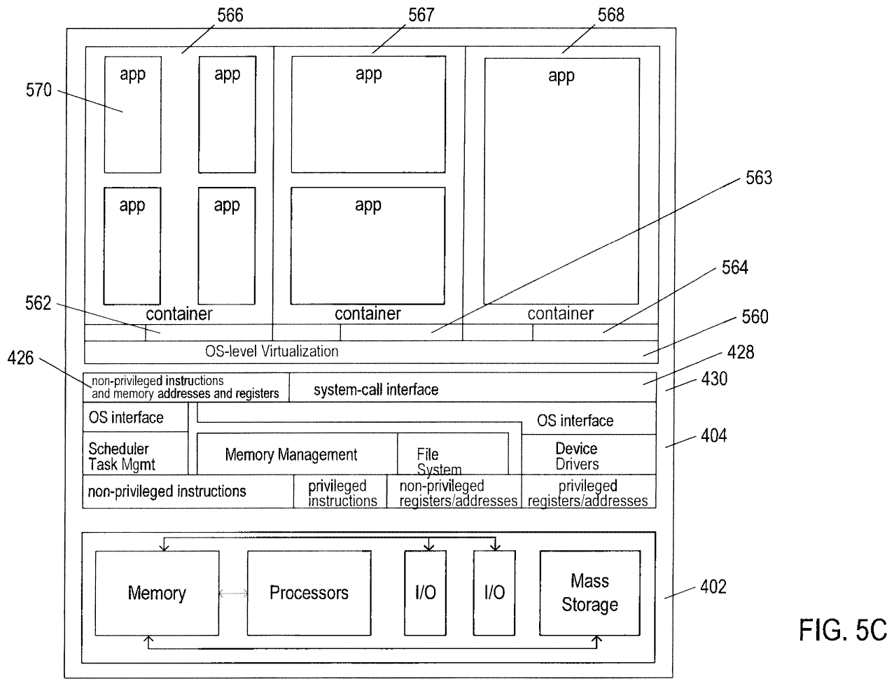

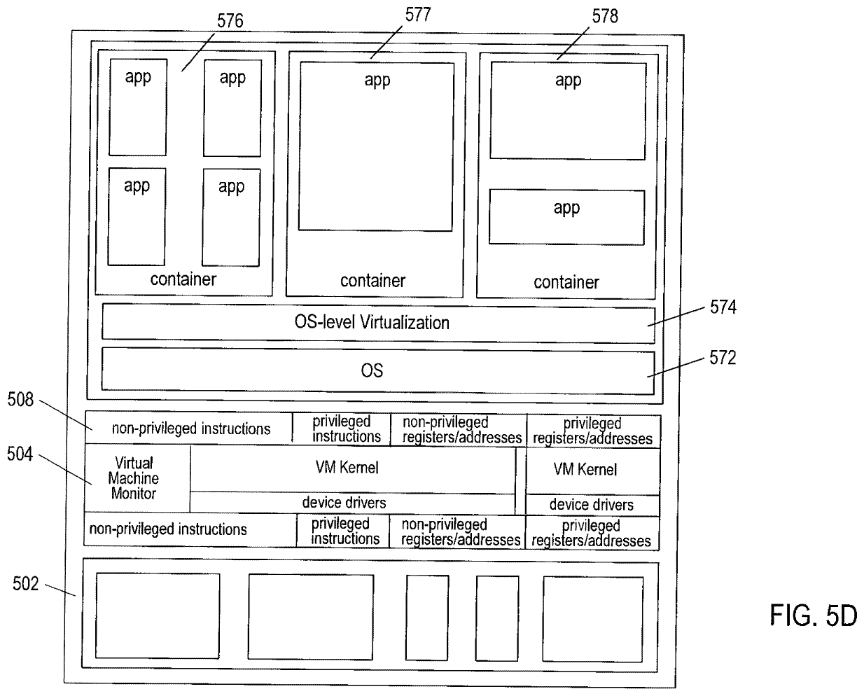

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems. OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system. without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

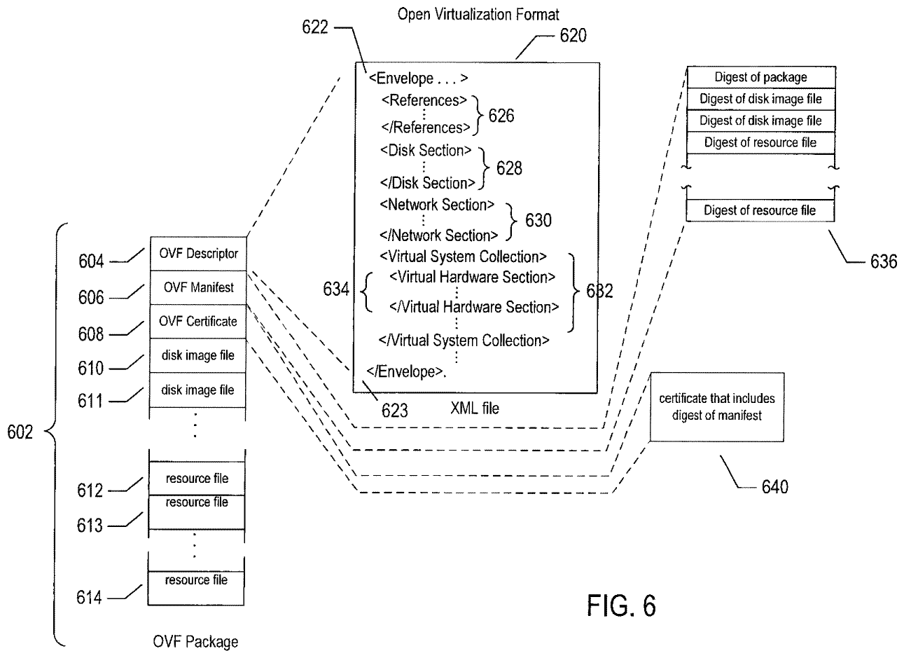

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

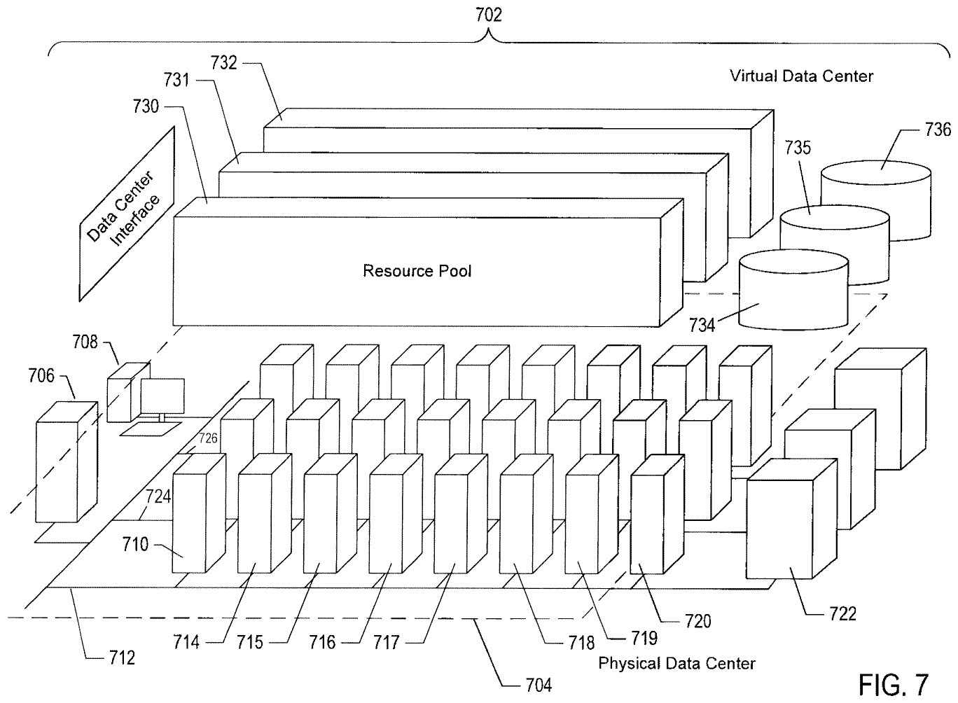

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

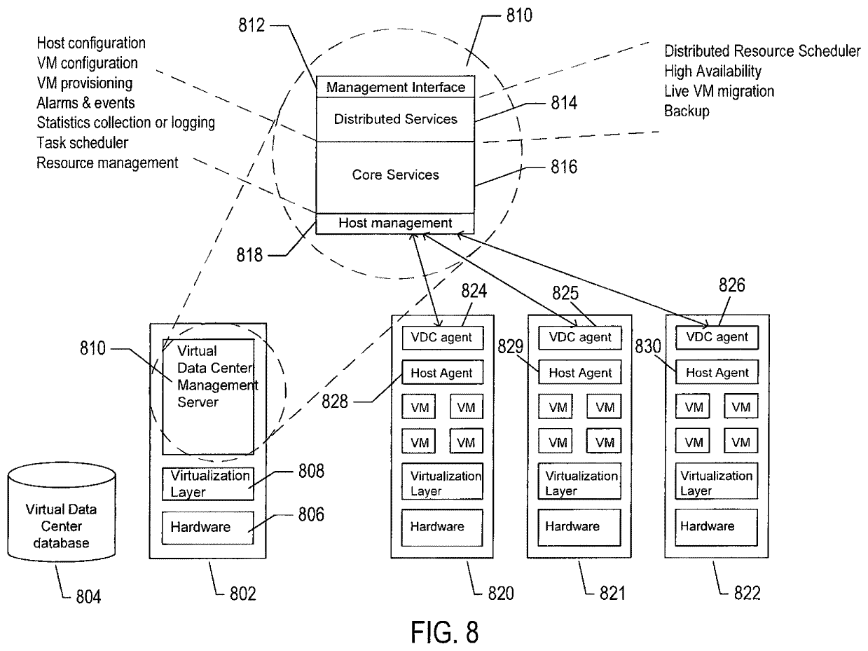

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine. encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server. relay virtual-machine provisioning and configuration-change commands to host agents, monitor and collect performance statistics, alarms, and events communicated to the virtual-data-center agents by the local host agents through the interface API. and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

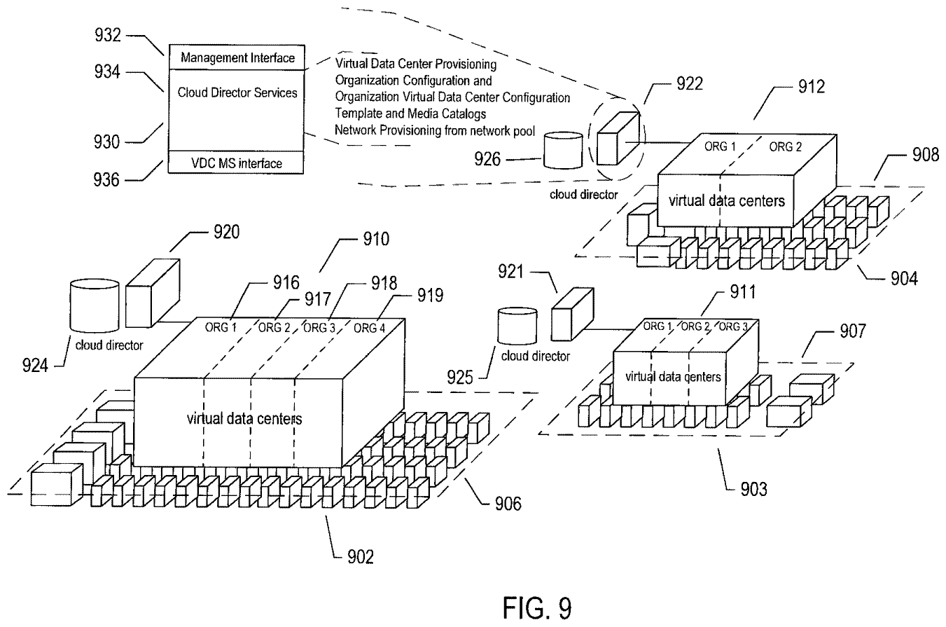

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

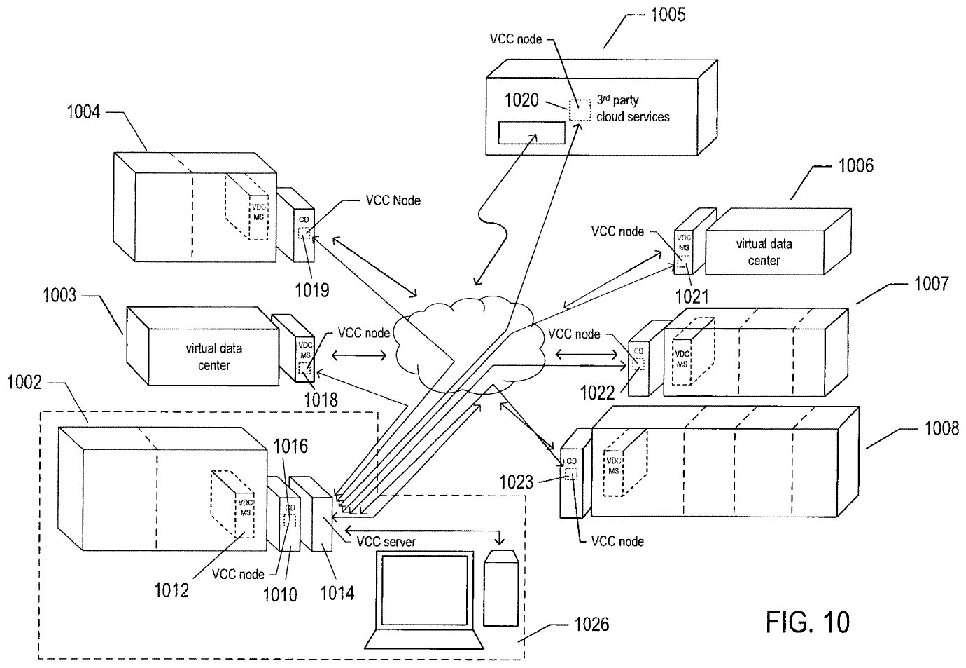

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Currently Disclosed Notification System

Although the currently disclosed methods and system are applicable to a wide variety of different types of distributed applications, they find particular application to distributed pipeline applications comprising multiple different service components and/or application components that together sequentially carry out one or more complex tasks. FIGS. 11A-B illustrate an example distributed pipeline application referred to as “VMware Code Stream.” VMware Code Stream is an automated release, continuous delivery, and continuous integration pipeline that enables frequent deployment of updated infrastructure and distributed applications. As shown in FIG. 11A, VMware Code Stream can be thought of as a multi-stage linear process, or pipeline, with three main stages 1102-1104, each comprising various substages and tasks. The first main stage “Build” 1102 builds an infrastructure or distributed application, according to a specification or blueprint, for deployment to a target cloud-computing environment specified by various input variables. The second main stage “Test” 1103 carries out comprehensive testing of the infrastructure or distributed application produced by the first stage. The final stage “Release” 1104 carries out various validation tasks and other tasks required to promote the infrastructure or distributed application to a production-quality release. The entire process proceeds along a linear pipeline comprising successive tasks and intermediate results that propagate downstream towards the final task of the final stage “Release.” However, when errors or anomalies occur during the process, particular stages, substages, tasks, or task subsets may be repeated. As shown in FIG. 11B, the stages, substages, and tasks 1110-1116 may be implemented and carried out by a variety of different service and/or application components 1120-1126, many of which are third-party services and/or application components.

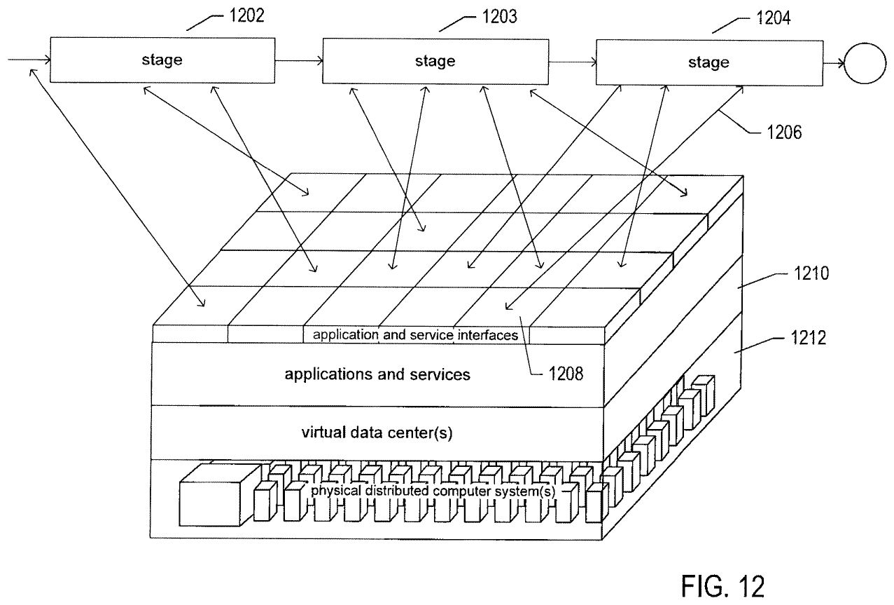

FIG. 12 provides a generalized illustration of a distributed pipeline application. In this example, the distributed pipeline application includes three stages 1202-1204. Each stage is implemented by one or more applications and/or services, as indicated by the double-headed arrows, such as double-headed arrow 1206, that connects a particular stage, such as stage 1204 in the case of double-headed arrow 1206, with a particular application or service interface, such as the application or service interface represented by the rectangular-tile-like representation 1208 of a particular interface of a particular application or service. As discussed above, each stage may be implemented by multiple applications and or services, and any particular stage, substage, or task can often be implemented by one of two or more alternative applications and/or services. The applications and services are implemented above one or more virtual data centers or cloud-computing environments 1210 that are, in turn, implemented above one or more physical distributed computer systems 1212, as discussed in the preceding subsection of this document.

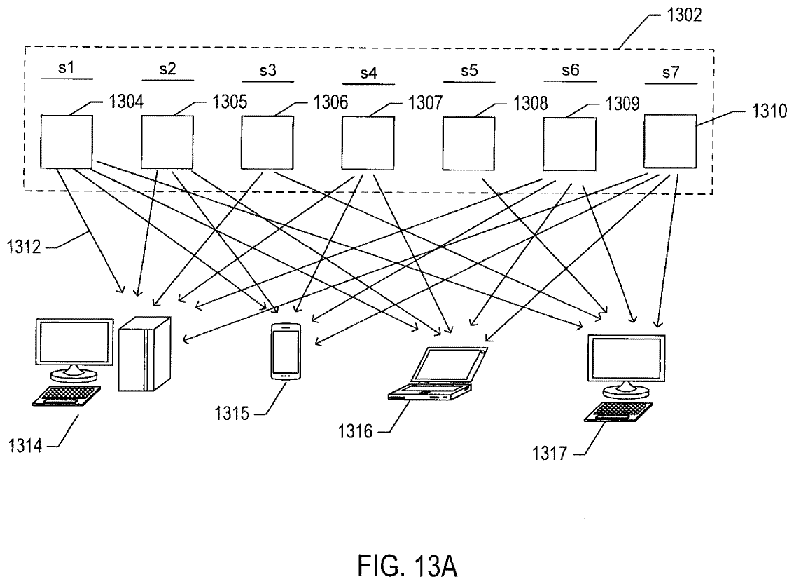

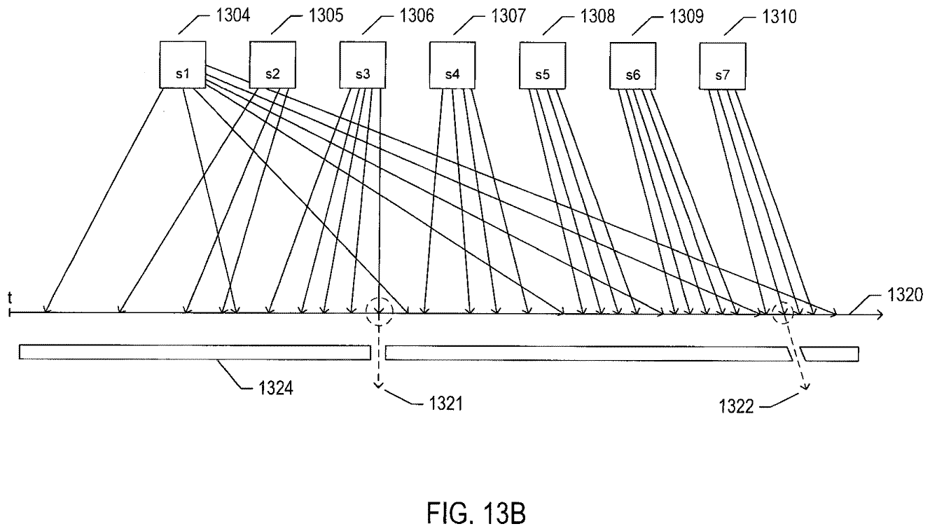

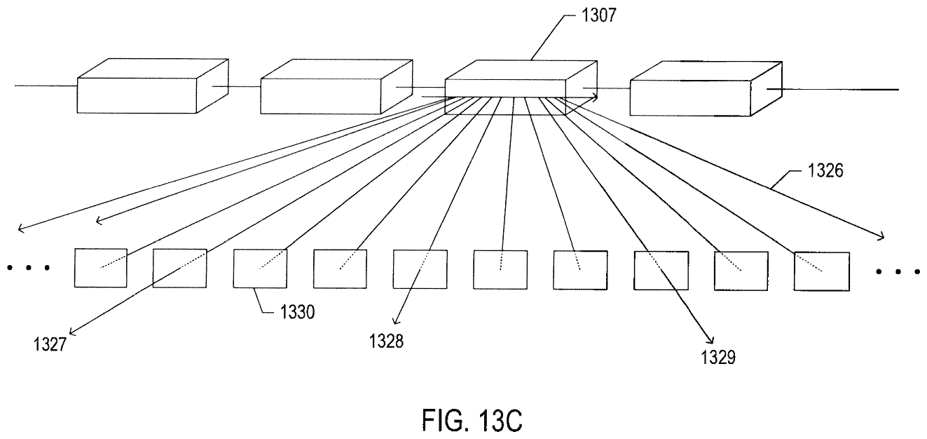

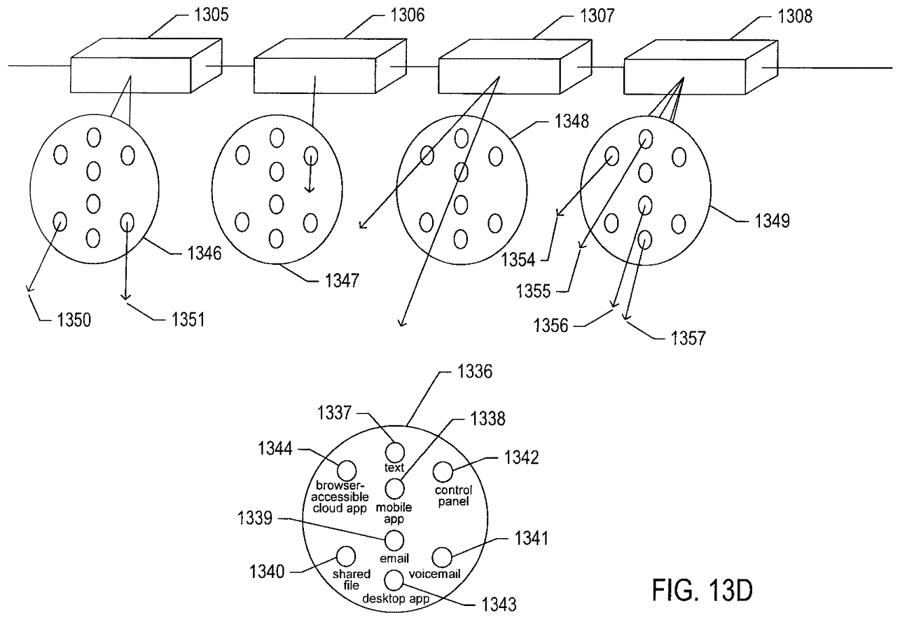

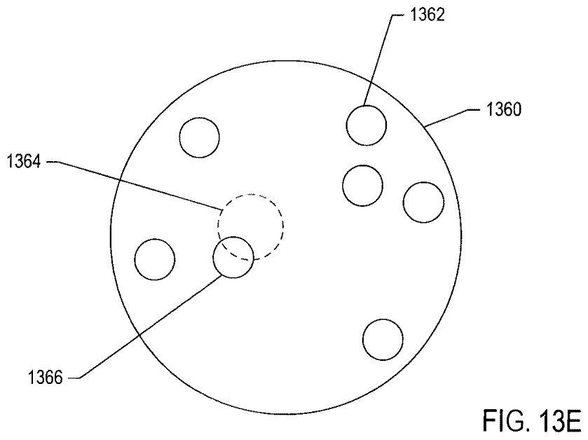

FIGS. 13A-E illustrate traditional notifications provided by a distributed pipeline application and various problems and deficiencies associated with traditional notifications. In FIG. 13A, an example distributed pipeline application 1302 is implemented by a number of service-oriented applications 1304-1310. During operation, each service-oriented application transmits notifications of various events and state changes, as represented by arrows, such as arrow 1312, to one or more of a variety of user devices 1314-1317 that receive and render the notifications to users. In general, each service-oriented application provides its own notification interface.

FIG. 13B illustrates a first problem associated with traditional notifications. In FIG. 13B, a horizontal timeline 1320 represents the time interval over which the distributed pipeline application carries out one or more operations. Over this time interval, various service-oriented-application components 1304-1310 may send a large number of notifications. However, a particular user may only be interested in a very few particular types of notifications 1321 and 1322. A system administrator or manager may attempt to erect a filter or barrier 1324 to filter out all but the desire notifications with respect to a particular user. However, this is a decidedly non-trivial task, for many reasons. For one reason, in this example, there are seven different service-oriented-application components, each providing a different notification interface. In order to devise a barrier or filter, the system administrator or manager may need to erect seven different filters or barriers-one for each service-oriented-application component of the distributed pipeline application. Furthermore, the timing of the notifications may be somewhat unpredictable, even when the beginning time of the overall process is known. Thus, it would be difficult or impossible to construct a barrier or filter, based on the timing of notifications, that would only pass a few particular notifications of interest to a particular user. Overwhelming users with large numbers of unneeded and undesired notifications is a well-known problem with notification systems, in general. Users may become numbed to notifications and may, as a result, fail to appreciate and detect important or relevant notifications. Of course, when there are many different users of a notification system, generating and transmitting huge numbers of undesired notifications may also represent a significant and wasteful computational overhead.

FIG. 13C illustrates problems associated with notifications generated by a single service-oriented-application component of a distributed pipeline application. In this example, the service-oriented-application component 1307 may generate a large number of different types of notifications, each represented by an arrow, such as arrow 1326. It may be the case that a particular user only desires to receive three of these various different types of notifications 1327-1329. A system administrator or manager, or perhaps the user receiving notifications, may attempt to construct a filter that passes the desired notifications but blocks the undesired notifications, as represented by a series of rectangles, including rectangle 1330. Here again, constructing such a filter may be quite problematic. For one thing, the desired notifications may include different content, so that it may be difficult to determine criteria that can be applied to all of the notifications generated by the service-oriented-application component in order to detect, and pass through to the user, a particular type of notification. This problem is compounded when the user desires to receive more than one type of notification. And, of course, as mentioned above, because this type of filtering process needs to be carried out over all of the different components of a distributed pipeline application, the difficulty of the task is manyfold compounded.

FIG. 13D illustrates yet another problem with traditional notifications. In the lower portion of FIG. 13D, disk 1336 represents all of the different types of target devices and different types of notifications that can be emitted through the notification interface of a service-oriented-application component of the example distributed pipeline application. In this example, the different types of notifications may include text messages sent to a smart phone 1337, messages transmitted to a mobile application running on a smart phone, laptop, tablet, or other user device 1338, email sent to any of many different types of devices 1339, notifications sent to a shared, distributed notification file 1340, voicemail notifications sent to a smart phone 1341, notifications displayed on the control panel of a distributed computer system 1342, notifications sent to a desktop application 1343, and notifications sent to a browser-accessible cloud application 1344. The disk representation of the various different types of notifications is used to represent the notification interfaces 1346-1349 of various different service-oriented-application components 1305-1308 of the distributed pipeline application. As indicated by arrows 1350-1351, service-oriented-application component 1305 supports voicemail and shared-distributed-file notifications only. By contrast, service-oriented-application component 1308 supports a much larger set of notification types, as indicated by arrows 1354-1357. The variety of notification types supported by different notification interfaces of the different service-oriented-application components of the example distributed pipeline application presents yet an additional set of problems to system managers and administrators as well as to notification recipients. A notification recipient, for example, many desired to receive notifications of a single type on a single device, but because of the differences in the notification interfaces of the different service-oriented-application components, this may not be possible. As a result, the user may need to monitor multiple different devices and multiple different types of notification-receiving applications and tools, which can greatly increase the possibility that the user will miss an important notification due to the complexity of the task of monitoring multiple devices, applications, and tools.

Finally, FIG. 13E illustrates yet an additional problem with traditional notifications. In FIG. 13E, disk 1360 represents the total amount of information available to a notification system with respect to events and state changes within a distributed pipeline application. Small discs with solid borders, such as disk 1362, represents that portion of the total amount of information that is provided through the notification interfaces of the component service-oriented applications of the distributed pipeline application. Dashed disk 1364 represents the information that a particular user may wish to receive in a notification. While the desired information partially overlaps a portion of the information available through the notification interfaces 1366, it includes a much larger amount of information that, while available within the distributed pipeline application, is not reported through existing notification interfaces. Thus, even having comprehensive knowledge of the different notification interfaces provided by the different service-oriented-application components of the distributed pipeline application, a user may still be unable to obtain the information desired by the user via traditional notifications.

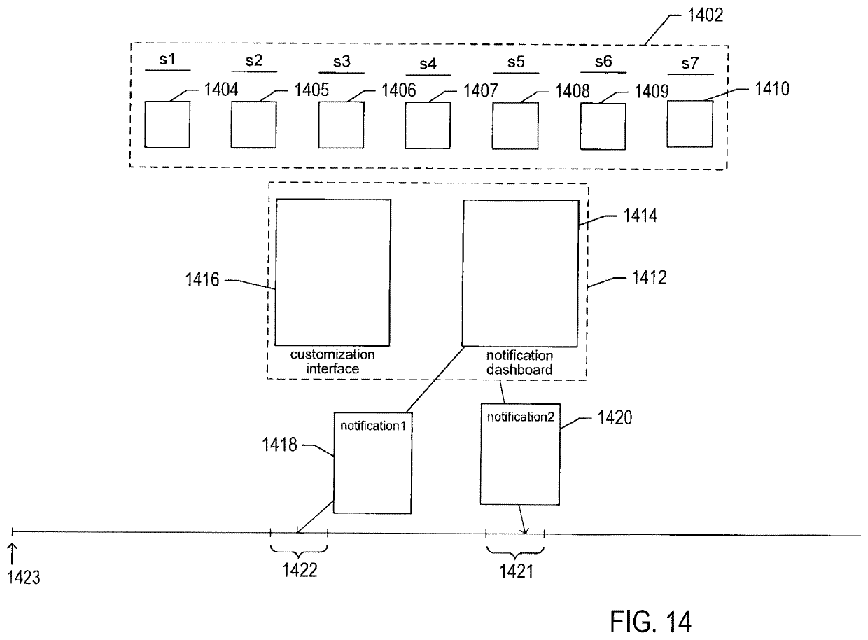

FIG. 14 illustrates an approach taken to improve notification by distributed pipeline applications and other types of distributed applications that is disclosed in the current document and claimed in the current claims. As discussed above, an example distributed pipeline application 1402 includes multiple service-oriented-application components 1404-1410. In the current approach, rather than using the notification interfaces provided by the service-oriented-application components, a new and improved notification system and notification-system interface 1412 is provided. The new notification-system interface 1412 includes, in one implementation, a notification dashboard 1414 and a customization interface 1416. The notification dashboard is a browser-accessible graphical display that displays notifications, that provides a user interface to allow a user to store and retrieve notifications, and that provides additional notification-related tools. The customization interface is browser-accessible and allows a user to specify exactly what types of notifications the user wishes to receive. The user can specify the information content of the desired notifications, target devices and notification methods, times and relative times for receiving different types of notifications, and other types of specifications. Thus, for example, a particular user may only wish to receive two different customized notifications 1418 and 1420 through the notification dashboard and may specify that these notifications be transmitted within specified time windows 1421 and 1422 relative to the time point 1423 at which particular distributed-pipeline-application tasks begin. There are many different types of customized notifications and notification parameters that can be specified to the customization interface to provide exactly the types of notifications and notification transmission desired by a user. This new notification-system interface, along with the new and improved notification system, discussed below, addresses all of the problems with traditional notifications discussed above with reference to FIGS. 13B-E. In many implementations of the new and improved notification system, the notification interfaces provided by component services and applications of the distributed pipeline application are not employed. Instead, the new and improved notification system directly accesses event and state-change information supplied through the application programming interfaces (“APIs”) of the component applications and services.

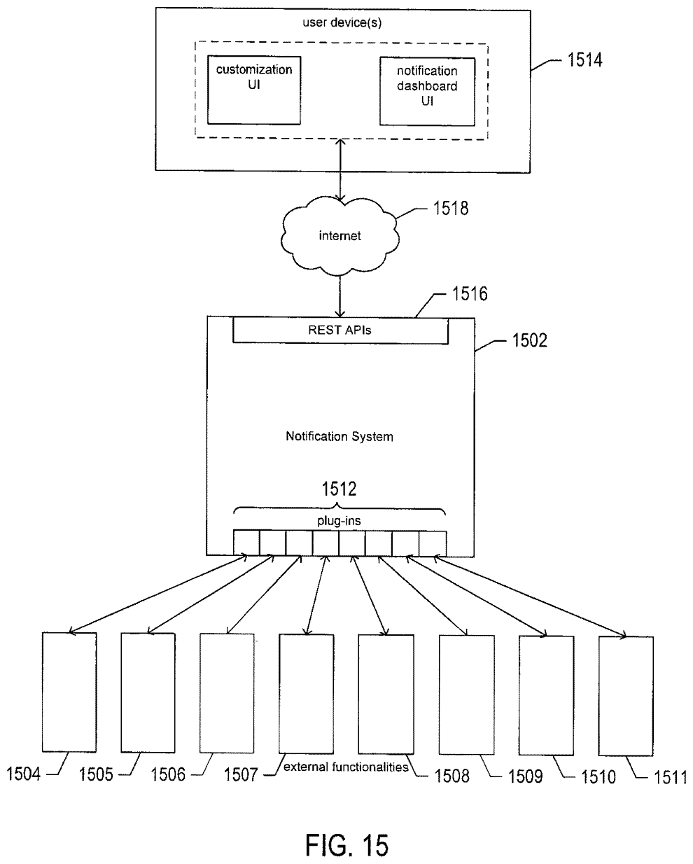

FIG. 15 illustrates the new and improved notification system disclosed in the current document. The new and improved notification system 1502 is implemented above the physical computing components of one or more distributed computer systems, such as data centers and cloud-computing systems. The new and improved notification system interfaces to component applications and services 1504-1511 via a set of plug-ins 1512 and interfaces to the new-notification-system interface 1514, discussed above with reference to FIG. 14, via Representational State Transfer (“REST”) API interfaces 1516 and the Internet 1518. A user may access the new-notification-system interface on any of many different types of devices using a web browser. In alternative implementations, the new-notification-system interface may also be made available through client-side applications and/or additional types of technologies.

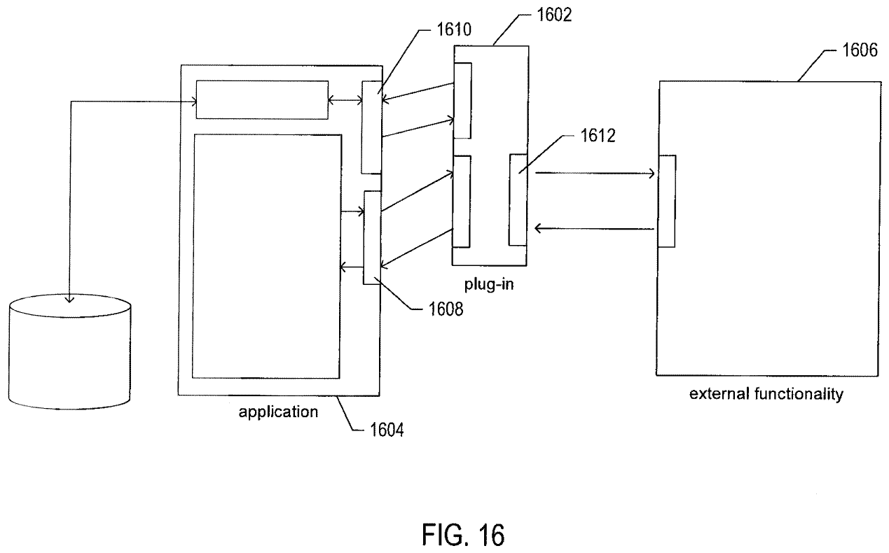

FIG. 16 illustrates a plug-in. A plug-in 1602 is a computer-instruction-implemented interface that allows an existing application 1604 to access the functionality provided by an external service or application 1606. The existing application provides a services interface 1608 and a data interface 1610 to the plug-in as well as an interface 1612 to the external service applications 1606. The services interface includes service entrypoints that allow the plug-in to register with the existing application and the data interface 1610 provides entrypoints that allow the plug-in to exchange data with the existing application. Thus, plug-ins implement a modular approach to incorporating functionality enhancements within application programs.

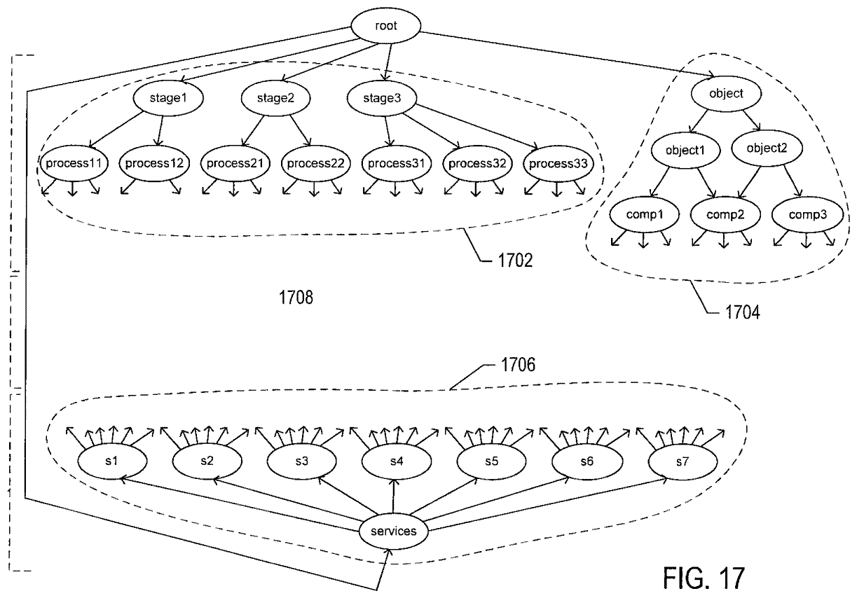

FIG. 17 illustrates an ontology used by the currently disclosed new and improved notification system. An ontology is essentially the definition of a vocabulary. There are many different ways for representing an ontology. One approach is to use a graph that includes nodes, representing the words of the vocabulary as well as various types of data values, such as strings, integers, and floating-point numbers, and links representing relationships between pairs of words and between words and data values. For example, a graph-represented ontology may include words that together represent the stages, substages, and tasks of a distributed pipeline application 1702, words that represent the types of entities operated on and produced by the distributed pipeline application 1704, and words that describe the component applications and services as well as the entities operated on and produced by the component applications and services 1706. A middle portion of the graph, 1708, not illustrated in FIG. 17, includes additional relationships, and may include additional nodes, that provide a mapping between the words related to the overall concept of the distributed pipeline application 1702 and 1704 and the words specific to the component services and applications that together implement the distributed pipeline application. This ontology can then be used to translate generic terminology related to the distributed pipeline application to component-specific terminology related to the component applications and services that implement the distributed pipeline application. This provides both a common language that allows users to specify the types of notifications that the user desires, through the customization interface (1416 in FIG. 14), which can be translated to equivalent component-specific terminology for specific components to allow the new and improved notification system to implement the customized notifications.

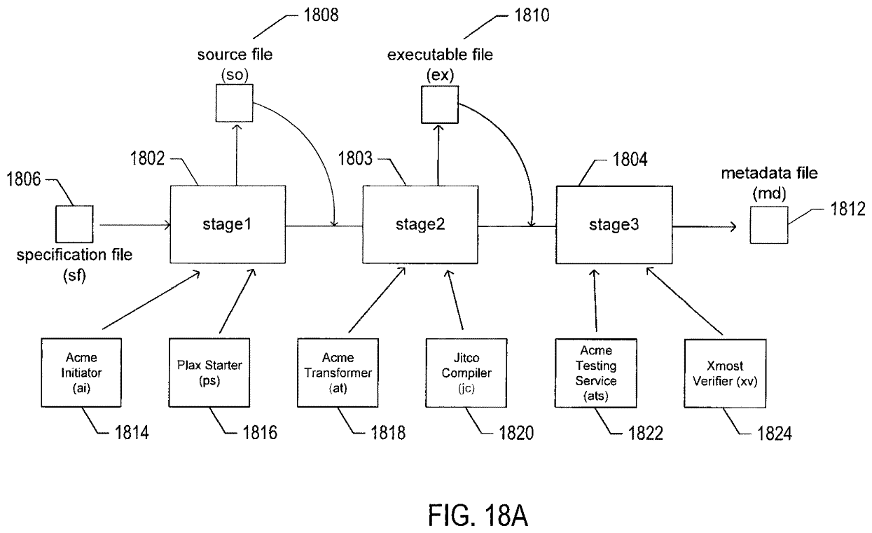

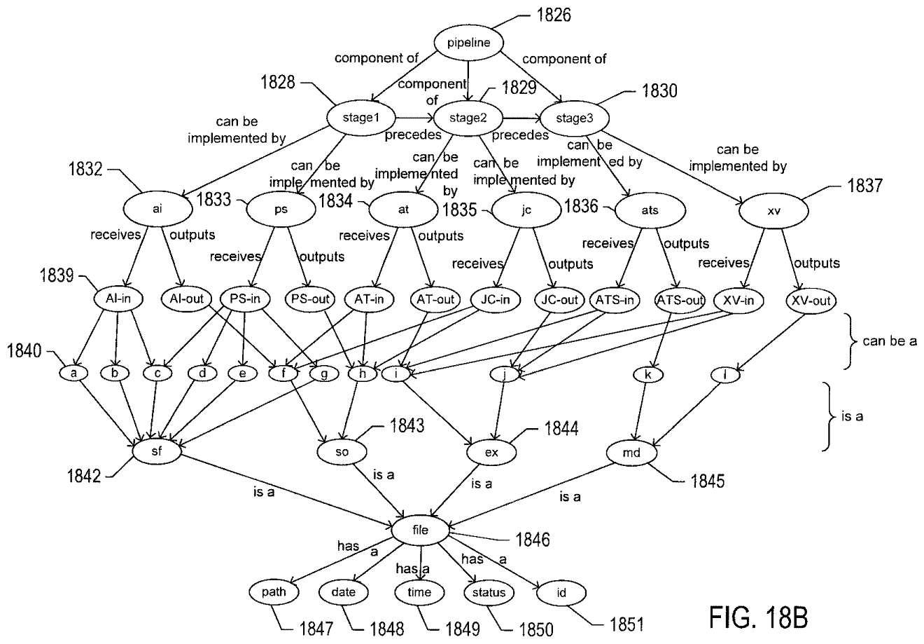

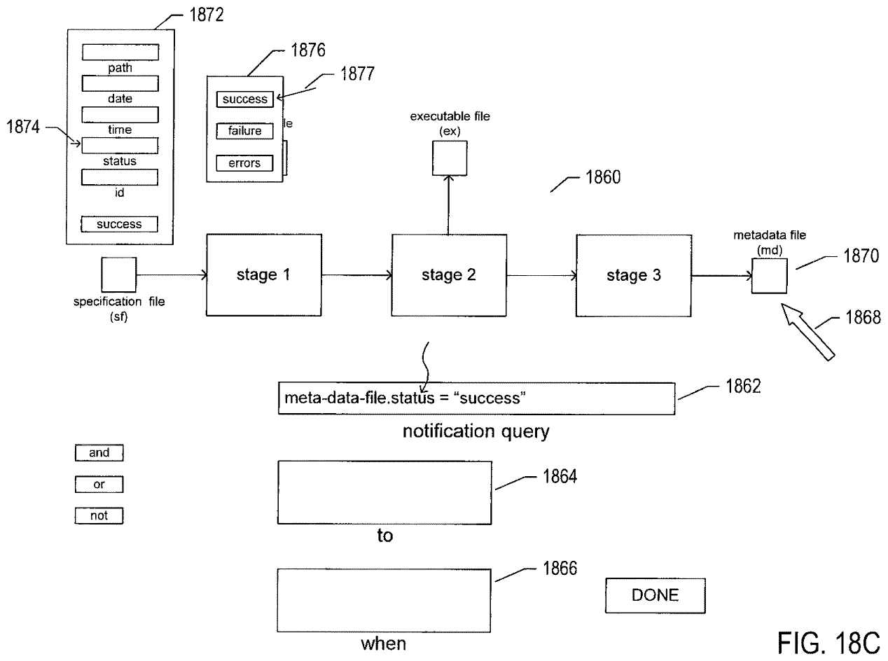

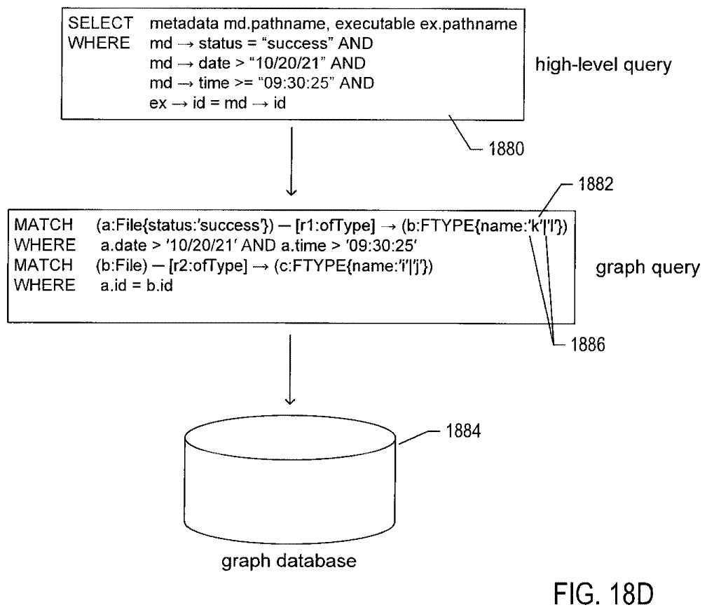

FIGS. 18A-D illustrate a simple example of how the currently disclosed new and improved notification system uses an ontology for obtaining customized, user-specified notifications and to implement the customized, user-specified notifications. FIG. 18A provides a high-level illustration of an example distributed pipeline application. The example the distributed pipeline application is composed of three stages 1802-1804. A specification file (“sf”), or blueprint, 1806 is input to the first stage 1802 of the distributed pipeline application. The first stage generates a source file (“so”) 1808 corresponding to the specification file, which is then input to the second stage 1803. The second stage 1803 generates an executable file (“ex”) 1810, which is then input to the third stage 1804. The third stage 1804 outputs a metadata file (“md”) 1812. In this simple example, most of the information relevant to notifications is associated with the various files input to, and generated by, the distributed application pipeline. The first stage 1802 can be implemented by one of two service-oriented applications: the Acme Initiator (“api”) 1814 and the Plax Starter (“ps”) 1816. The second stage 1803 can be implemented by one of two service-oriented applications: the Acme Transformer (“at”) 1818 and the Jitco Compiler (“jc”) 1820. The third stage 1804 can be implemented by one of two service-oriented applications: the Acme Testing Service (“ats”) 1822 and the Xmost Verifier (“xv”) 1824.

FIG. 18B provides a graph-represented ontology for the simple distributed pipeline application introduced with reference to FIG. 18A. This graph is a simple, generic graph that does not follow the conventions of any particular graph-based data-modeling vocabulary, mentioned below. A root node 1826 represents the entire vocabulary for the distributed pipeline application. Three lower-level nodes 1828-1830 represent the three stages of the distributed pipeline application. A next level of nodes 1832-1837 represent the various alternative service-oriented-application components that can be used to implement the three stages. A fourth level of nodes, beginning with node 1839, represent the file inputs and outputs for the service-oriented-application components. A fifth level of nodes, beginning with node 1840, represent the file types for the input and output files, using single-lower-case-letter abbreviations. A six level of nodes, beginning with node 1842, represent the type or class of file to which each of the file types belongs, the file types or classes including specification files 1842, source files 1843, executable files 1844, and metadata files 1845. These file classes are subclasses of the entity class “file” 1846. Each file is associated with a pathname 1847, a date 1848, a time 1849, a status 1850, and an ID 1851. The arrows, or links, in the ontology graph shown in FIG. 18B represent relations between nodes.

FIG. 18C illustrates a portion of the customization graphical user interface (“GUI”) of the new and improved notification system. The illustrated portion of the customization GUI allows a user to input a query that is subsequently executed to retrieve and return the notification information desired by a user for a particular type of desired notification. The GUI displays a portion of the graphical representation of the distributed pipeline application 1860 previously shown in FIG. 18A. In addition, the GUI includes a text-entry window 1862 that displays the text of a query that is being constructed by a user via graphical operations. A second text-entry window 1864 allows a user to specify delivery targets of the notification and a third text-entry window 1866 allows a user to specify desired time ranges or relative time ranges for notification transmission. The second and third text-entry windows 1864 and 1866 may display the results of graphical operations, like the first text-entry window 1862. Of course, the customization GUI is generally far more complex, provides far more query-construction and notification-delivery-specification features, and includes many different pages or screens. In the illustrated example, a user has moved a cursor 1868 to reference the metadata file icon 1870, bringing up a file-attributes-selection window 1872. Input, by the user, to the status field 1874 brings up a list of possible status values 1876. Arrow 1877 represents input, by the user, of a selection of the status value “success.” This results in a first clause in the query being constructed in text-entry window 1862. Additional graphical operations can be used to build an entire notification-query expression. The query is built from the pipeline vocabulary represented by the upper portion of the ontology shown in FIG. 18B. The ontology is used, by the new and improved notification system, to provide a common language for notification customization, relieving the user of the need to know specific terminology related to the particular service-oriented-application components that implement a particular instance of the distributed pipeline application.

FIG. 18D illustrates use of the ontology to map generic terminology to component-specific terminology in order to construct and execute a query that retrieves information for a particular type of customized notification from a graph database. Once a user has graphically specified the desired information through the customization interface, as discussed above with reference to FIG. 18C, the new and improved notification system generates a corresponding query 1880 in a high-level query language, such as the SPARQL query language. The query 1880 shown in FIG. 18D is written in a generic, hypothetical query language. The query indicates that the user wishes to be notified when a metadata file associated with the status attribute “success” is generated by the distributed pipeline application and that the user wishes to receive the path names of the metadata file as well as the executable file from which the metadata file was generated. The high-level query is then translated, by the new and improved notification system, into a lower-level graph-database query 1882 that can be executed to retrieve the desired information from a graph database 1884. During the process of translating the high-level query to the graph query, in this simple example, the new and improved notification system uses the ontology to replace generic or common terminology with component-specific terminology in order to access the relevant data that is stored in the form of component-terminology triples within the graph database. For example, the common-language file type “metadata” used in the high-level query is replaced by a specific component-relevant file types 1886 in the graph query. Enabling users to use a common, generic vocabulary for referring to the distributed pipeline application greatly simplifies the task of constructing queries to retrieve the information desired for particular types of notifications. Otherwise, as discussed above, a user would need to know all of the particular component APIs and particular component terminologies. The common, generic vocabulary also vastly simplifies the customization interface. In addition, the new and improved notification system continuously monitors the component APIs in order to update the ontology, so that the ontology provides an encapsulation of the types of information that can be accessed by the new and improved notification system through component APIs. The example of FIGS. 18A-D is deliberately simplistic, to facilitate the current discussion. Ontologies used by notification-system implementations are generally quite complex and can provide a basis for devising many different types of complex queries in order to extract exactly the types of information desired by users of the notification system.

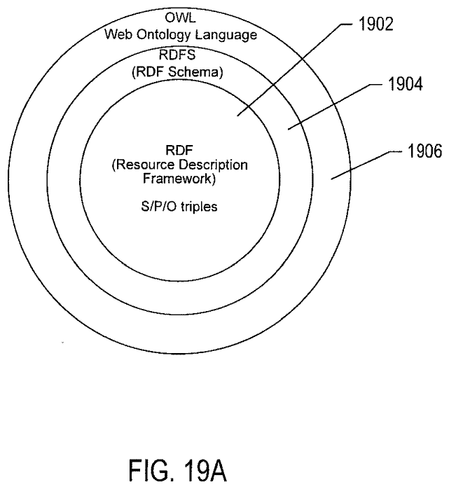

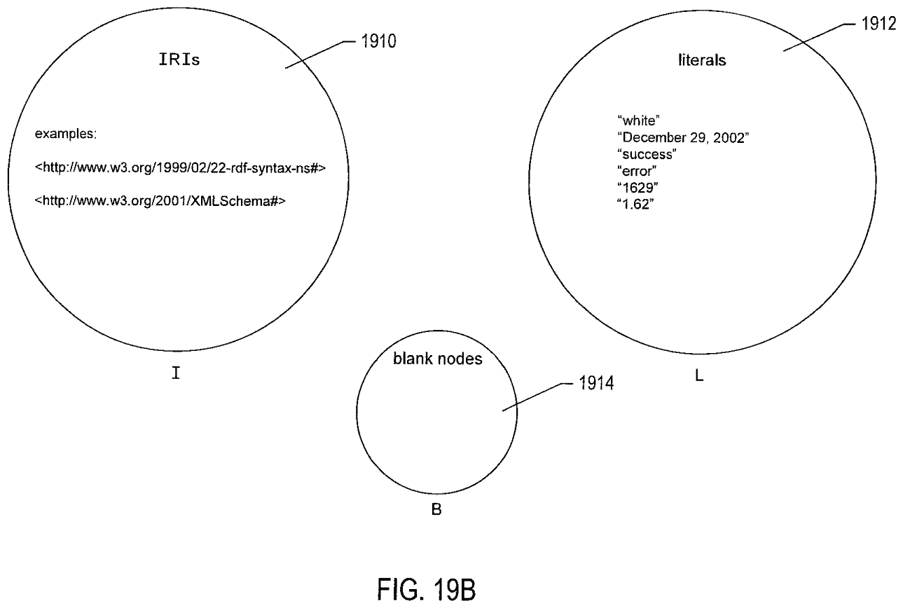

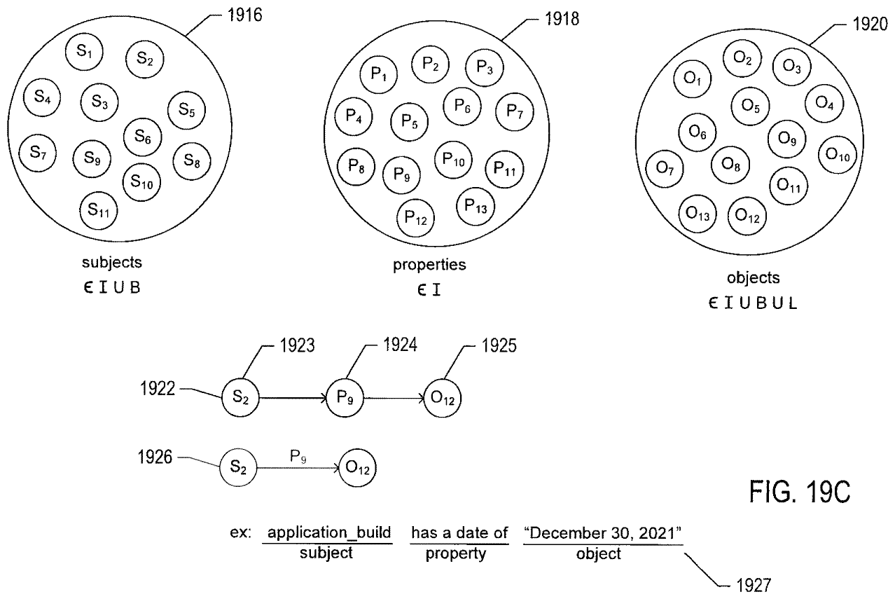

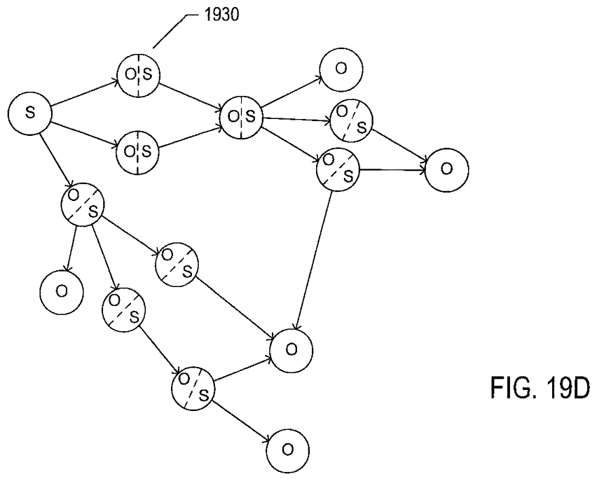

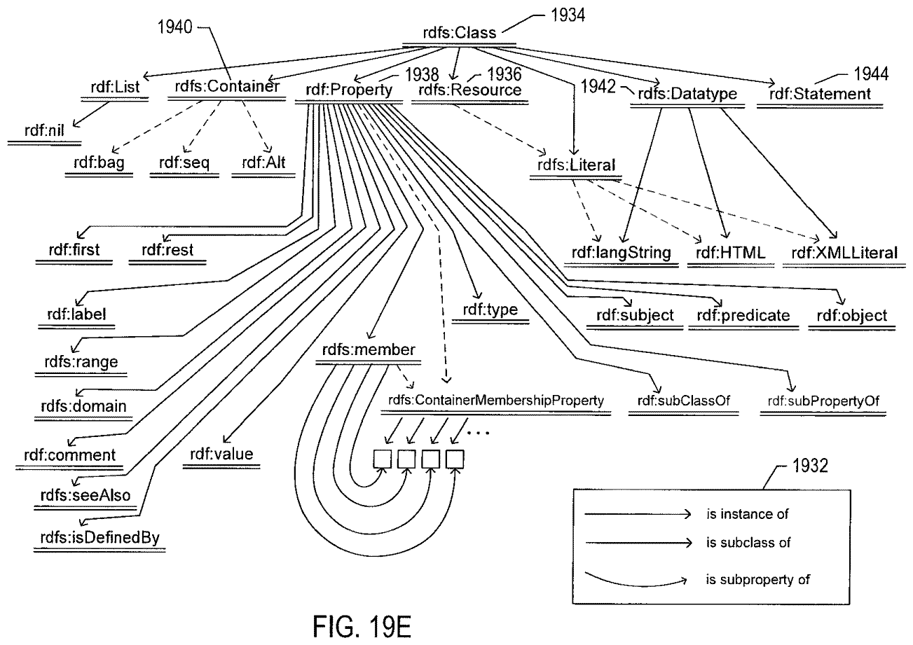

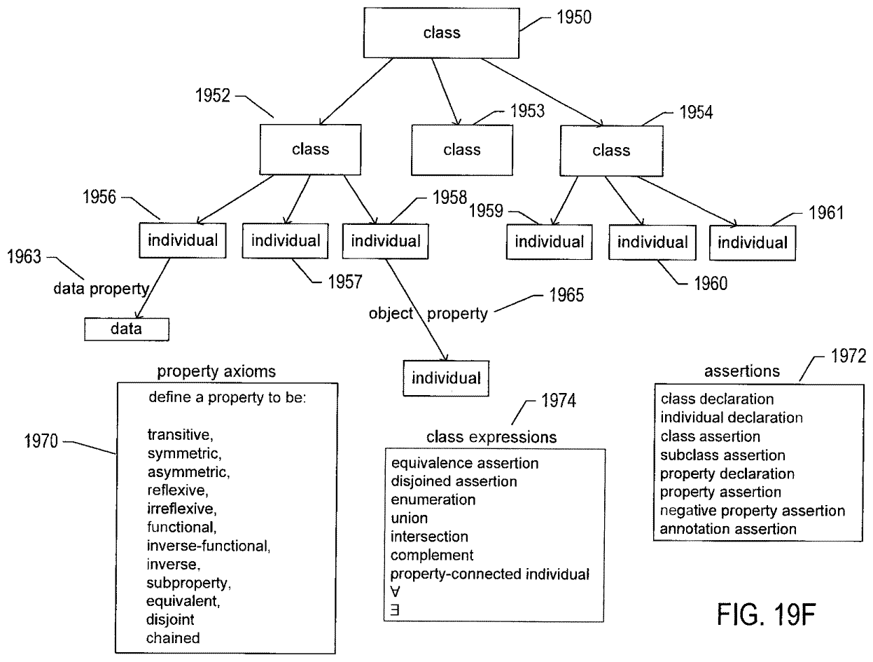

FIGS. 19A-F provide an overview of a family of graph data-modeling vocabularies that can be used to implement the currently disclosed notification system. FIG. 19A shows the relationships between three different graph-based data-model conventions. A Resource Description Framework (“RDF”) graph 1902 is a relatively simple graph data model based on subject-predicate-object triples. The RDF Schema (“RDFS”) data-modeling vocabulary 1904 is a superset of RDF, as discussed below. The Web Ontology Language (“OWL”) 1906 is a data modeling vocabulary built on top of RDFS. Any of these three graph-based modeling languages can be used to represent an ontology, and a graph database that stores RDF triples can be used as the graph database incorporated within the currently disclosed notification system.

FIG. 19B illustrates three different types of RDF-graph nodes, or entities. These include IRIs 1910, which are internationalized versions of uniform resource identifiers (“URIs”), literals 1912, which includes string literals, integer literals, and floating-point literals, and a blank nodes 1914, which are essentially unnamed nodes. FIG. 19C illustrates the basic subject-predicate-object triples that are the basis for both RDF graphs and RDF-graph databases. Subjects 1916 are nodes, or entities, that include IRIs and blank nodes. Properties 1918 are represented as annotated links between nodes, and are IRIs. Objects 1920 are nodes, or entities, that include IRIs, blank nodes, and literals. An RDF triple 1922 comprises a subject 1923, a predicate 1924, and an object 1925. This is commonly represented, in an RDF-graph representation, as the subject and object nodes connected by a link annotated with the predicate 1926. RDF triples are essentially short declarative sentences, as indicated by the RDF triple 1927 in FIG. 19C. FIG. 19D shows a larger RDF graph. The graph is composed of RDF triples, but a given node, such as node 1930, may be both an object with respect to an incoming link and a subject with respect to an outgoing link. Such dual-purpose nodes allow triples to be connected together into a network-like graph. The RDF data model includes various additional features, including lists, several types of container, including bags and sequences, labels, and various types of literals.

FIG. 19F illustrates features of the RDFS data-modeling vocabulary. In FIG. 19E, RDF features have names with the prefix “rdf” and RDFS features have names with the prefix “rdfs.” FIG. 19E. shows a class hierarchy for the RDF and RDFS features. Key 1932 indicates that solid straight arrows represent the relation “is an instance of,” dashed straight arrows represent the relation “is a sub class of,” and solid curved arrows represent the relation “is a sub property of.” RDFS introduces the notion of classes 1934, a resource class 1936, a properties class 1938, a container class 1940, a data type class 1942, and an RDF-statement class 1944. RDFS extends RDF to provide for describing groups of related resources and relationships between these resources. RDFS also provides for specifying the domains and ranges of properties.

FIG. 19F illustrates features of the OWL data-modeling vocabulary. In the OWL vocabulary, basic entities include classes 1950, subclasses of classes 1952-1954, individuals 1956-1961, which are members of classes, data properties 1963, which link individuals to data values, and object properties 1965, which link one individual to another individual. In addition, OWL provides for properties to be defined according to various different property axioms 1970, provides for various types of assertions 1972, and provides for various types of class expressions 1974. Properties, for example, can be transitive, symmetric, asymmetric, reflexive, or reflexive. Classes can be constructed via union, intersection, complement, and enumeration via class expressions. Assertions can be used to declare classes, individuals, class membership, and other such relationships. OWL is commonly used for specifying ontologies.

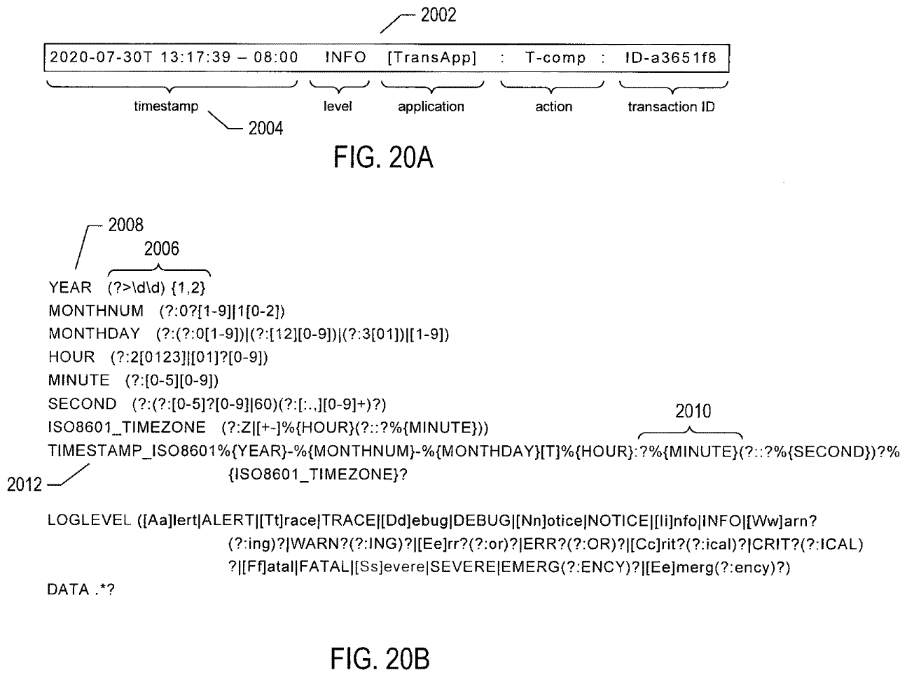

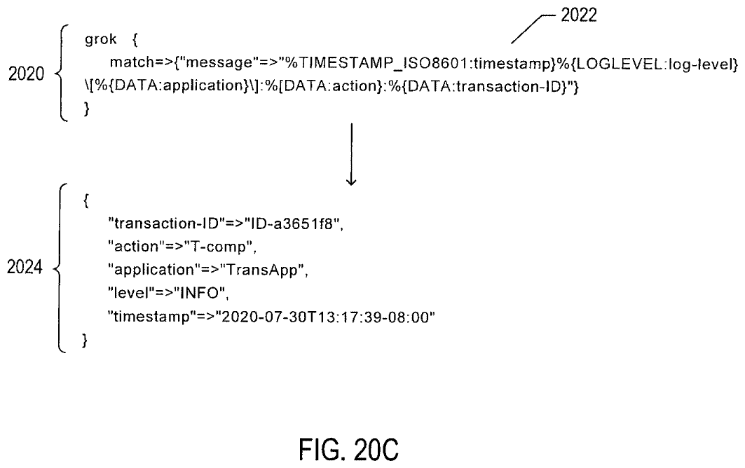

FIGS. 20A-C illustrate use of regular expressions. An example formatted text or message 2002 is shown at the top of FIG. 20A. The five different fields within the message are indicated by labels, such as the label “timestamp” 2004, shown below the message. FIG. 20B includes a variety of labeled regular expressions that are used, as discussed below with reference to FIG. 20C, to extract the values of the discrete fields in the message 2002. For example, regular expression 2006 follows the label YEAR 2008. When this regular expression is applied to a character string, it matches either a four-digit indication of a year, such as “2020,” or a two-digit indication of the year, such as “20.” The string “\d\d” matches two consecutive digits. The “(?>“and ”)” characters surrounding the string “\d\d” indicates an atomic group that prevents unwanted matches to pairs of digits within strings of digits of length greater than two. The string “{1, 2}” indicates that the regular expression matches either one or two occurrences of a pair of digits. A labeled regular expression can be included in a different regular expression using a preceding string “% {“ and a following symbol”},” as used to include the labeled regular expression MINUTE (2010 in FIG. 20B) in the labeled regular expression TIMESTAMP_ISO8601 (2012 in FIG. 20B). There is extensive documentation available for the various elements of regular expressions.

Grok parsing uses regular expressions to extract fields from text or text-based messages. The popular Logstash software tool uses grok parsing to extract fields from log/event messages and encode the fields according to various different desired formats. For example, as shown in FIG. 20C, a call to the grok parser 2020 is used to apply the quoted regular-expression pattern 2022 to the message 2002 shown in FIG. 20A, producing a formatted indication of the contents of the fields 2024. Regular-expression patterns for various different types of text, messages, and text-encoded information returned from API calls can be developed to identify and extract fields from the text, messages, and text-encoded information. When the grok parser unsuccessfully attempts to apply a regular-expression pattern to text, messages, and text-encoded information, an error indication is returned. The Logstash tool also provides functionalities for transforming input text, messages, and text-encoded information into event tuples.

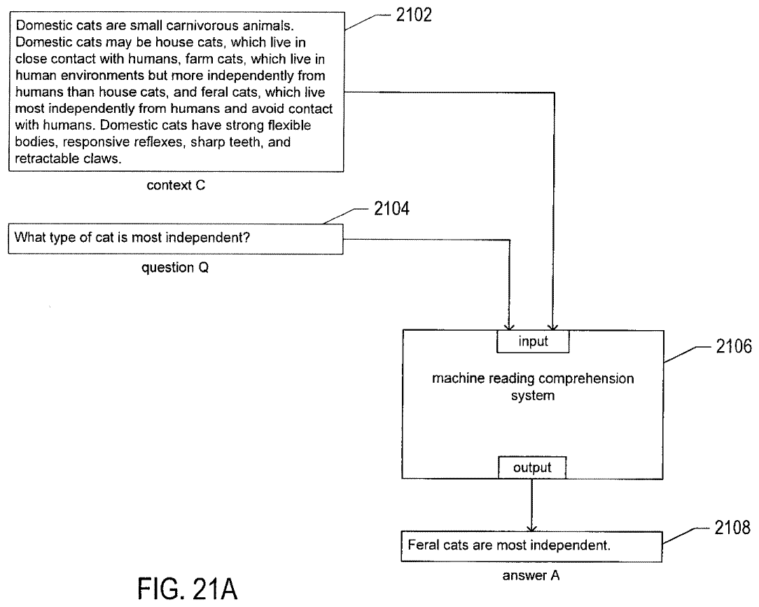

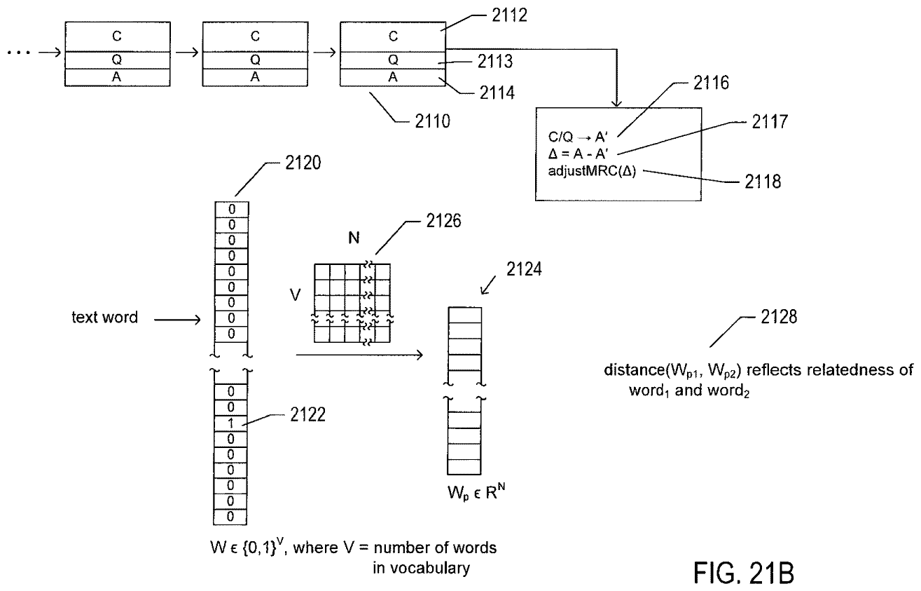

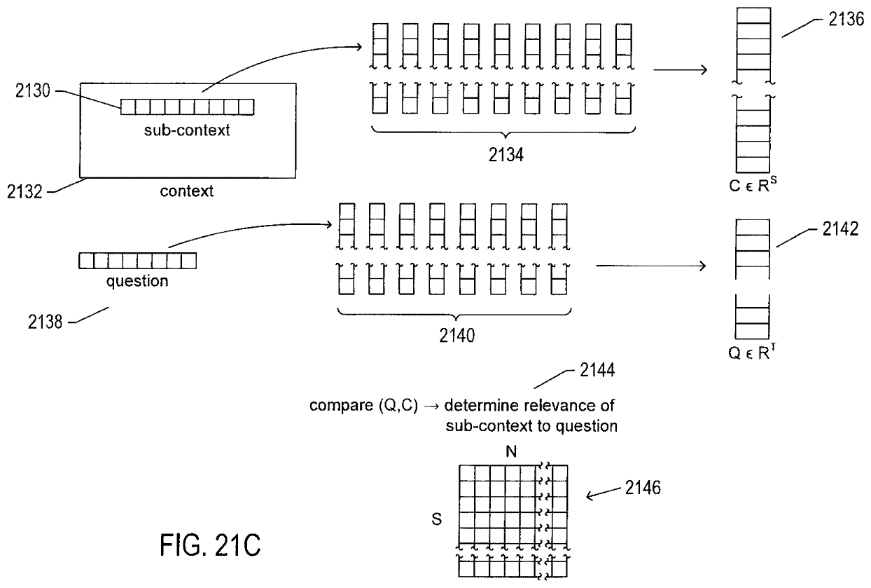

FIGS. 21A-C illustrate semantic-similarity-based machine-reading-comprehension (“MRC”) systems. MRC systems are commonly used in natural-language processing for various operations that involve selecting phrases or sentences from contextual passages. One important example is for formulating answers to questions related to a contextual passage. In FIG. 21A, an example contextual passage 2102 and question 2104 are shown as inputs to an MRC system 2106. The MRC system generates an answer 2108 to the question. MRC systems do not attempt to actually understand the contextual passage, but instead use various types of vector-space-based operations and heuristics to identify portions of the contextual passage related to the question and then use the identified portions to answer the question. As shown in FIG. 21B, MRC question-answering systems need to be trained, using training data, in order to provide answers to questions. The training data consists of a series or stream of examples, such as example 2110, each of which includes a contextual passage 2112, a question related to the contextual passage 2113, and an appropriate answer to the question 2114. For each example in the training dataset, the MRC system generates a proposed answer A′2116, computes some type of distance metric between the proposed answer and the answer included in the training-data example 2117, and adjusts parameters and weights to minimize the distance 2118 were the proposed answer A′ recomputed using the adjusted parameters and weights.

In many MRC systems. words in the contextual passage and question are mapped to vectors. Initially, the words are mapped to a type of vector 2120 that includes a different element for each different word in the considered vocabulary. The mapping of a word to this type of vector results in a vector with a single entry, such as entry 2122 in vector 2120, having the value 1 and all other entries having the value 0. These vectors are elements of a vector space of dimension V, where V is the number of words in the vocabulary. These initial vectors are then mapped to vectors of a real-number-based vector space 2124 of much smaller dimension N by a mapping encoded in an V×N embedding matrix 2126, each row of which corresponds to an N-dimensional vector representing a particular word in the vocabulary. The mapping incorporates semantic relationships between words into the N-dimensional vectors so that a distance computed by vector subtraction of the two N-dimensional vectors reflects the semantic relationship between the words represented by the two vectors 2128. As shown in FIG. 21C, a subcontext 2130 of adjacent words within a contextual passage 2132 is initially represented as a set of corresponding word vectors 2134 which are submitted to various types of machine-learning entities, such as recurrent neural networks and convolutional neural networks, to generate a single-vector representation of the subcontext 2136. Similarly, a question 2138 is initially represented by a set of word vectors 2140 and then processed via machine-learning entities to produce a single vector 2142 representing the question. A comparison operation 2144, in certain implementations based on a matrix computed from the subcontext and question vectors 2146, can then be applied to the subcontext and question vectors in order to determine the relatedness of the question to the subcontext represented by the subcontext vector. An operation that considers successive contexts within the contextual passage and computes the relatedness of the question to each of the successive contexts can then determine those subcontexts most closely related to the question, which provides a basis for generating an answer to the question. MRC systems are well-known and mature, and there are many different types of MRC-system implementations used for a variety of different problem domains.

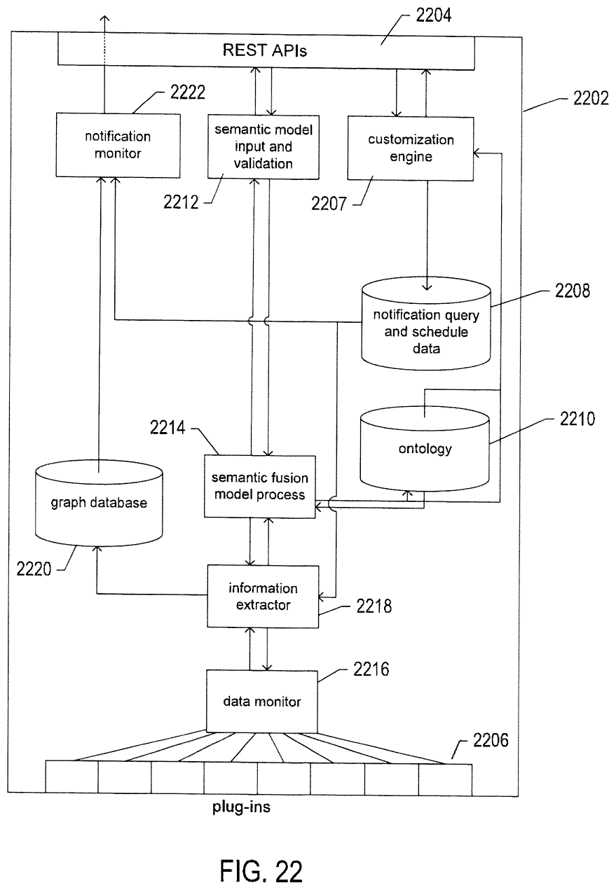

FIG. 22 shows a block diagram for one implementation of the currently disclosed new and improved notification system. As mentioned above, with reference to FIG. 15, the notification system 2202 interfaces through REST APIs 2204 to the customization interface (1416 in FIG. 14) and notification dashboard (1414 in FIG. 14) of the notification interface (1412 in FIG. 14) and interfaces through plug-ins 2206 to the component applications and services of a distributed application. The customization interface, notification-query construction, and notification scheduling is implemented by a customization engine 2207. A notification-query-and-schedule-data database 2208 stores notification queries and scheduling information for customized notifications on behalf of users of the notification system. An ontology, implemented in OWL, RDFS, or RDF in many notification-system implementations, is stored in an ontology database 2210. The ontology is initially input through the customization interface to a semantic-model-input-and-validation module 2212 and used by a semantic-fusion-model process 2214 to produce the initial ontology stored in the ontology database 2210. However, the notification system includes a data monitor 2216 that periodically accesses component applications and services to extract new semantic data from the component applications and services which is forwarded to an information extractor 2218 which identifies information potentially related to new semantic features requiring ontology updates and transfers that information to the semantic fusion model process 2214 for processing and ontology updating. The data monitor also extracts the status and event information from the component applications and services which is forwarded to the information extractor for processing into graph-database queries that are then executed to store the extracted information into a graph database 2220. A notification monitor 2222 continuously monitors notification schedules stored in the notification-query-and-schedule-data database 2208 to determine when to execute notification queries and transmit the data retrieved by the queries in the graph database as notifications to users of the notification system. The notifications are generally sent to the notification dashboard, but may also be transmitted to various different user devices.

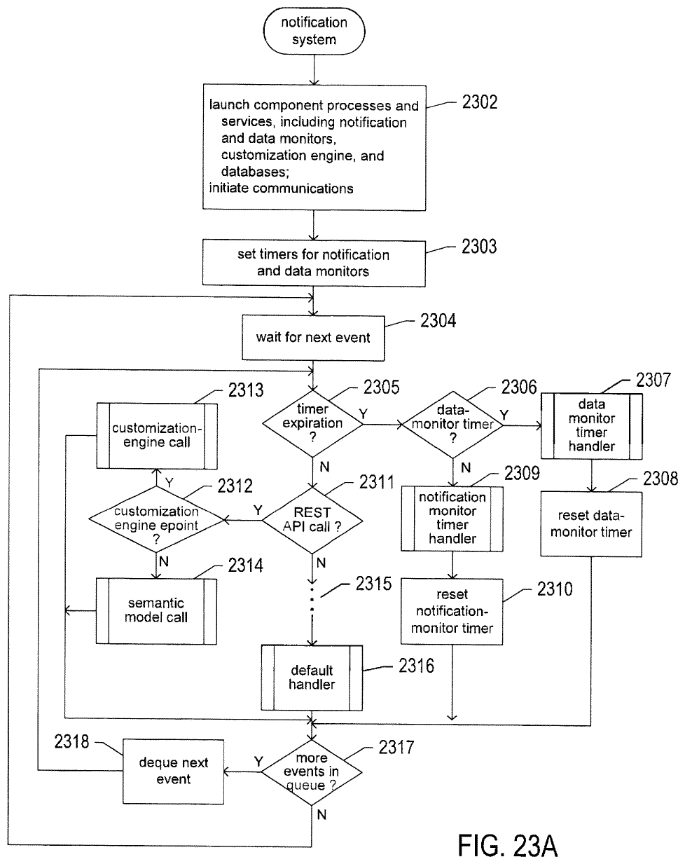

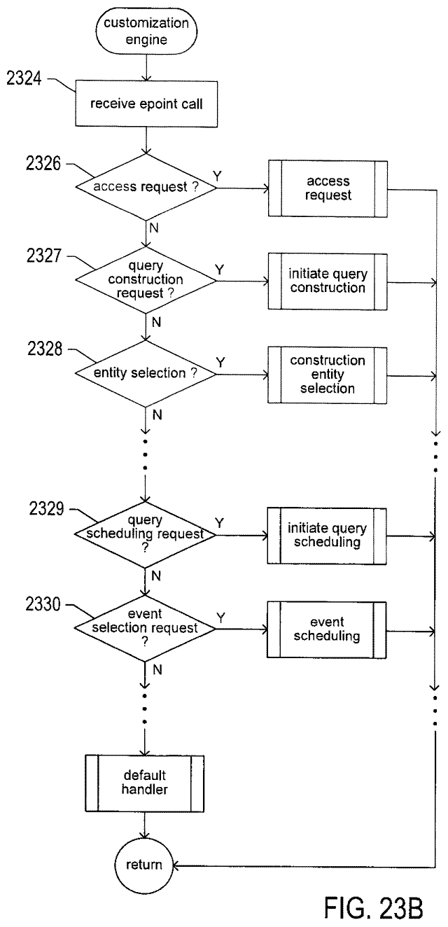

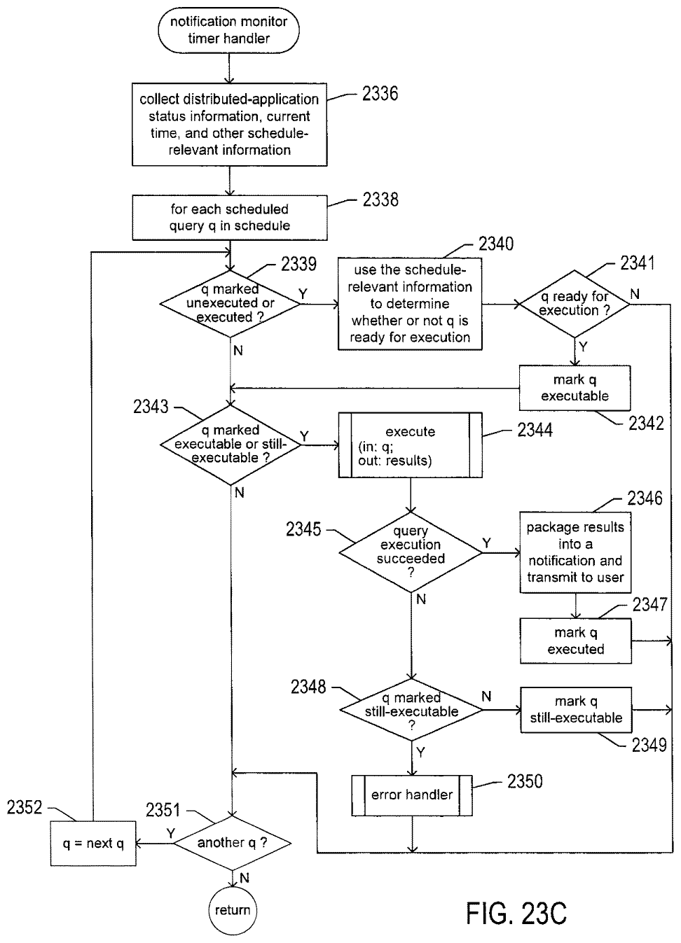

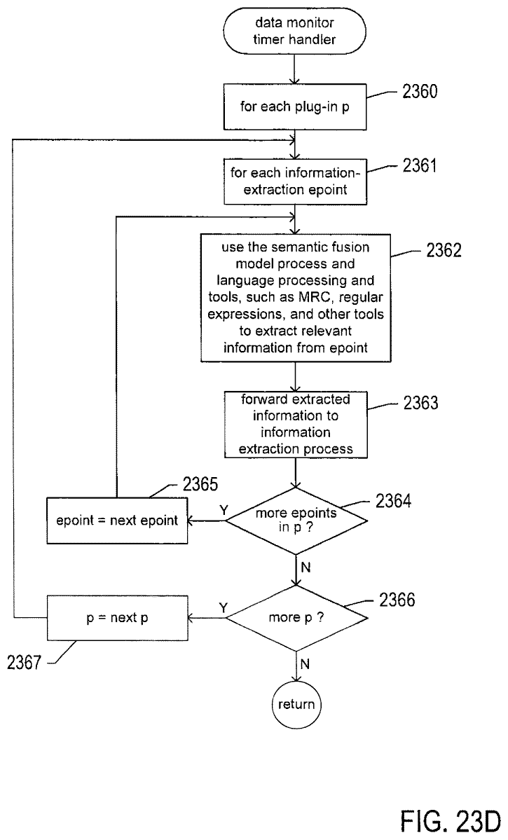

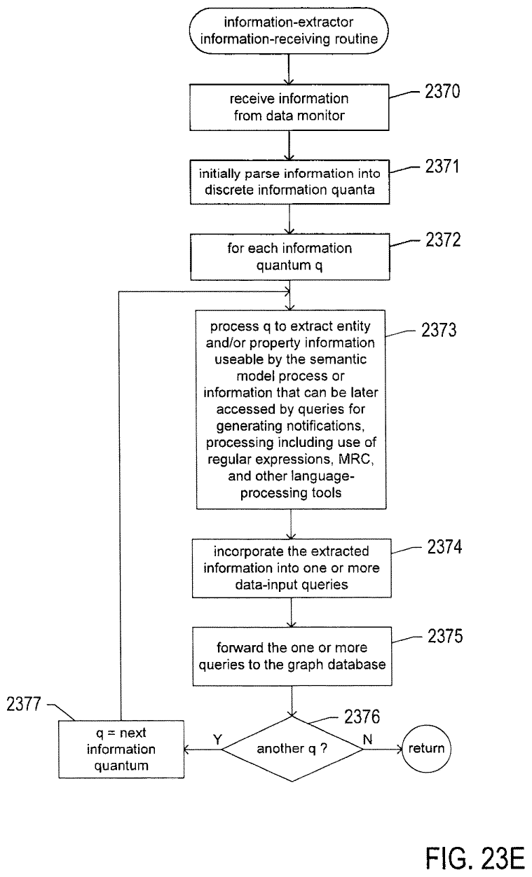

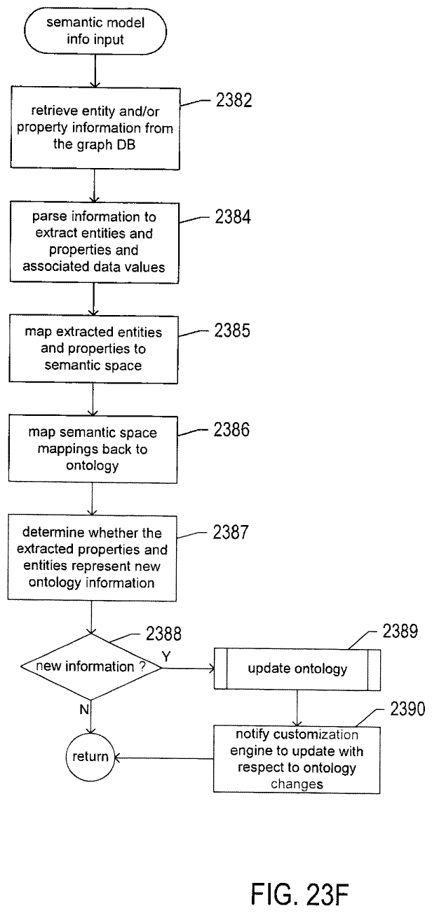

FIGS. 23A-F provide control-flow diagrams that illustrate implementation and operation of the components of the currently disclosed notification system, introduced above with reference to FIG. 22. FIG. 23A provides a control-flow diagram for the notification system, as a whole. The system is logically modeled as a continuous event loop in which the system waits for the occurrences of various types of event, including timer expirations, reception of service calls and requests through the REST API interface (2204 in FIG. 22), and other types of events, and call event-handler routines to handle each event. In step 2302, the notification system launches the various component applications and services, if they are not already resident and operational, launches the component processes internal to the notification system, and initiates communications between the various processes. In step 2303, the notification system sets notification-monitor and data-monitor timers. Then, in step 2304, the notification system waits for a next event to occur. When the next occurring event is a timer expiration, as determined in step 2305. and when the timer expiration is a data-monitor-timer expiration, as determined in step 2306, a data-monitor-timer handler is called, in step 2307, to access the information provided by component applications and services via the plug-in interfaces, as discussed above. Upon completion of the data-monitor-timer handler, the data-monitor timer is reset, in step 2308. When the timer expiration is for the notification-monitor timer, a notification-monitor-timer handler is called, in step 2309, to determine whether there are any notifications to transmit to users of the notification system. Following completion of the notification-monitor-timer handler, the notification-monitor timer is reset, in step 2310. When the next occurring event is a call to the REST-API interface, as determined in step 2311, and when the call is made to a customization-engine entrypoint, as determined in step 2312, a customization-engine routine is called, in step 2313, to carry out the task corresponding to the called entrypoint. Otherwise, when a semantic-model entrypoint was called, a semantic-model routine is called, in step 2314, to carry out the task corresponding to the call to semantic-model entrypoint. Ellipsis 2315 indicates that additional types of events may be handled in the event loop of steps 2304-2318. A default handler 2316 handles any rare or unexpected events. Following handling of the most recently handled event, when there are more events that have been queued, as determined in step 2317, a next event is dequeued, in step 2318, and control flows back to step 2305. Otherwise, control flows back to step 2304, where the notification system waits for a next event to occur. Thus, the notification system, at its core, operates as an event loop to handle internal timer events, interface events, and other events.

FIG. 23B shows a control-flow diagram for the customization-engine routine called in step 2313 of FIG. 23A. In step 2324, the customization-engine routine receives an indication of the called entrypoint. Then, in a series of conditional steps 2326-2330, the customization-engine determines which entrypoint was called and calls a corresponding routine to carry out the tasks represented by the called entrypoint. Tasks include log-in requests and other access requests, request to initiate query construction via the customization interface, requests to initiate query scheduling via the customization interface, and many other tasks carried out in order to provide is the notification-dashboard and customization-interface functionalities. FIG. 23B provides an indication of the call-driven operation of the customization engine (2207 in FIG. 22). In many cases, entrypoint calls result in direct associated-routine execution.

FIG. 23C provides a control-flow diagram for the notification-monitor-timer handler called in step 2309 of FIG. 23A. In step 2336, the notification-monitor-timer handler accesses the notification-query-and-schedule-data database (2208 in FIG. 22), other internally stored data, and various assistant routines to collect distributed-application status information, the current time, and notification-schedule information in order to determine which notification queries to execute on behalf of notification-system users during the current monitoring interval represented by the notification-monitor-timer expiration. Then, in the for-loop of steps 2338-2352, the notification-monitor-timer handler considers each notification query q stored in the notification-query-and-schedule-data database. Queries are marked with one of labels “unexecuted,” “executed,” “executable,” and “still-executable.” Of course, the label text may vary in different implementations, or numeric labels may be used in place of text labels. The label “unexecuted” indicates that the query has not yet been executed. The label “executed” indicates that the query was successfully executed when last considered by the notification-monitor-timer handler. The label “executable” indicates that the query should be executed at first opportunity, since a notification corresponding to the query is scheduled for execution. The label “executable” indicates that the query should be re-executed at first opportunity, because the first attempt to execute the query failed. When the currently considered query is marked “unexecuted” or “executed,” as determined in step 2339, the handler uses the information collected in step 2336 to determine whether or not the currently considered query q is ready for execution. A query is ready for execution when the corresponding notification is sent when notification information is available in the graph database (2220 in FIG. 22) and the corresponding notification is scheduled to be sent as soon as the information is available. Alternatively, a query may be ready for execution when the current time reaches or exceeds a specified value, according to the query-schedule information. There are many different scheduling parameters that can control the timing of query notification and corresponding notification transmission. When the currently considered query q is ready for execution, as determined in step 2341, the query q is marked as “executable,” in step 2342, and control flows to step 2343. Otherwise, control flows to step 2351, from where the for-loop of steps 2338-2352 either undertakes a next iteration, when there are additional notification queries to consider, or terminates. In step 2343, the handler determines whether the currently considered query q is marked as “executable” or “still-executable.” When the currently considered query is so marked, a call is made to the routine “execute,” in step 2344, to execute the query to retrieve notification information from the graph database (2220 in FIG. 22). When query execution succeeds, as determined in step 2345, the results returned from query execution are packaged into a notification and transmitted to the user, in step 2346. Then, in step 2347, the currently considered query q is marked as “executed.” If query execution failed, and if the currently considered query q is marked “still-executable,” as determined in step 2348, an error handler is called in step 2350, since execution of the query has twice failed. Otherwise, in step 2349, the currently considered query q is marked as “still-executable,” so that the query can be retried in the next call to the notification-monitor-timer handler.

FIG. 23D provides a control-flow diagram for the data-monitor-timer handler called in step 2307 of FIG. 23A. In the outer for-loop of steps 2360-2367, the data-monitor-timer handler considers each plug-in p. In the inner, nested for-loop of steps 2361-2365, the data-monitor-timer handler considers each entrypoint in the plug-in interface of the currently considered plug-in p from which notification information can be extracted. In step 2362, the data-monitor-timer handler uses the semantic-fusion-model process (2214 in FIG. 22) and various language-processing tools, such as the above-mentioned regular expressions and/or MRC to extract relevant information from the currently considered entrypoint. In step 2363, the extracted information is forwarded to the information extractor (2218 in FIG. 22).

FIG. 23E provides a control-flow diagram for an information-receiving routine through which the information extractor receives notification information from the data-monitor-timer handler. In step 2370, the routine receives extracted information from the data monitor (2216 in FIG. 22). In step 2371, the received information is parsed into discrete information quanta, using regular expressions, semantic similarity, and other techniques. Then, in the for-loop of steps 2372-2377, each information quantum q extracted from the received information is considered. In step 2373, language-processing tools, including one or more of regular expressions, MRC, semantic-similarity detection, and other such tools, are used to extract entity and/or property information usable by the semantic model process to update the ontology and/or information that can be later accessed for generating notifications. In step 2374, the extracted information is incorporated into one or more graph-database data-input queries. In step 2375, the one or more data-input queries are is forwarded to the graph database for input of the extracted information to the graph database. The for-loop of steps 2372-2377 continues to iterate until all of the extracted information quanta have been processed.

FIG. 23F provides a control-flow diagram for an information receiving routine through which the semantic-fusion-model process received information from the information extractor process. In step 2382, the routine retrieves entity and/or property information from the graph database. In step 2384, the retrieved information may be further parsed, using regular expressions, MRC, and/or other techniques, to extract entities, properties, and associated data values. In step 2385, the extracted entities and properties are mapped to semantic space. In step 2386, the semantic-space mappings are mapped back to the ontology. In step 2387, the routine determines whether or not the translated properties and entities represent new ontology information when extracted properties and entities represent new ontology information, as determined in step 2388, and update-ontology routine is called, in step 2389, to update the ontology. Following completion of the update-ontology routine, the customization engine is notified, in step 2390, to carry out any updates needed so that the customization engine provides services consistent with the updated ontology. Of course, ontology updates may involve adding new information to the ontology, but may also involve changing or deleting information already resident within the ontology.

The present invention has been described in terms of particular embodiments, it is not intended that the invention be limited to these embodiments. Modifications within the spirit of the invention will be apparent to those skilled in the art. For example, any of many different implementations of the new and improved notification system can be obtained by varying various design and implementation parameters, including modular organization, control structures, data structures, hardware, operating system, and virtualization layers, and other such design and implementation parameters. In alternative implementations, different types of information stores and ontology representations may be used.

1. An improved notification system associated with a distributed application that runs within a distributed computer system having multiple computer systems, communications networks, and data-storage devices, the notification system comprising:
a first interface through which the improved notification system accesses application and service components of the distributed application;
a second interface through which the notification system provides a notification dashboard and a customization interface; and
a stored ontology that provides a mapping between a vocabulary that represents the distributed application and distributed-application-component-specific vocabularies, enabling the notification system to construct customized notification from distributed-application-vocabulary input to the customization interface.

2. The improved notification system of claim 1 wherein the first interface comprises multiple plug-ins, each plug-in interfacing the notification system to a corresponding distributed-application application component and or component.

3. The improved notification system of claim 1 wherein the first interface comprises a first REST API through which the improved notification system provides the customization interface and a second REST API through which the improved notification system provides the notification dashboard.

4. The improved notification system of claim 1 wherein the distributed application is a distributed pipeline application.

5. The improved notification system of claim 1 wherein the ontology is represented by a graph-based data modeling vocabulary, including a data modeling vocabulary selected from:
a Resource Description Framework (“RDF”) data modeling vocabulary;
an RDF Schema (“RDFS”) data modeling vocabulary; and
a Web Ontology Language (“OWL”) data modeling vocabulary.

6. The improved notification system of claim 1 wherein.

7. The improved notification system of claim 1 wherein the improved notification system further includes:
a notification-query-and-schedule-data database;
a semantic-model-input-and-validation module;
a semantic-fusion-model process;
a data monitor;
a notification monitor;
an information extractor; and
a notification-information database.

8. The improved notification monitor of claim 7 wherein the notification-query-and-schedule-data database stores queries used to extract notification information from the notification-information database and scheduling information that controls when the queries are executed in order to generate and transmit notifications containing the extracted notification information.

9. The improved notification monitor of claim 7 wherein the semantic-model-input-and-validation module receives an initial ontology, validates the received ontology, and forwards the validated ontology for persistent storage within the notification system.

10. The improved notification monitor of claim 7 wherein the semantic-fusion-model process uses information obtained from distributed-application component services and applications to periodically update the ontology.

11. The improved notification monitor of claim 7 wherein the data monitor periodically requests information from the distributed-application component services and applications, including information that is relevant to ontology updates and notification information that is subsequently transmitted in notification, and furnishes the information returned by the distributed-application component services and applications to the information extractor.

12. The improved notification monitor of claim 7 wherein the notification monitor periodically accesses the notification-query-and-schedule-data database and other scheduling-related information to determine which of the queries stored in the notification-query-and-schedule-data database to execute during a current monitoring interval.

13. The improved notification monitor of claim 7 wherein the information extractor parses and semantically processes information received from the data monitor, forwarding information related to the ontology to the semantic-fusion-model process and storing notification information into the notification-information database by generating queries and forwarding the queries to the notification-information database.

14. The improved notification monitor of claim 7 wherein the notification-information database is a graph database that stores subject-predicate-object triples that together represent notification information.

15. The improved notification system of claim 1 wherein the customization interface is a browser-accessible interface through which users specify desired notifications by specifying one or more of:
the notification information to be included in the notifications;
the device or devices to which notifications are to be transmitted; and
time ranges or relative-time ranges for notification delivery.

16. The improved notification system of claim 1 wherein the notification dashboard is a browser-accessible interface through which users receive, view, and store and through which users access stored notifications.

17. A method that provides notifications of events and state changes that occur within a distributed application, the method comprising:
generating and storing, within a notification system, an ontology that provides a mapping between a vocabulary that represents the distributed application and distributed-application-component-specific vocabularies;
using the ontology to provide a web-browser-accessible customization interface through which notifications are specified by specifying one or more of
notification information to be included in the notifications,
device or devices to which notifications are to be transmitted, and
time ranges or relative-time ranges for notification delivery;
providing a web-browser-accessible notification dashboard through which users receive, view, and store and through which users access stored notifications;
periodically monitoring distributed-application components to obtain new information for updating the ontology; and
periodically monitoring notification schedules to determine when to transmit notifications to target devices on which the notification dashboard is displayed.

18. The method of claim 17 wherein the ontology is represented by a graph-based data modeling vocabulary, including a data modeling vocabulary selected from:
a Resource Description Framework (“RDF”) data modeling vocabulary;
an RDF Schema (“RDFS”) data modeling vocabulary; and
a Web Ontology Language (“OWL”) data modeling vocabulary.

19. The method of claim 18 wherein notifications are transmitted by:
executing a stored query associated with the notification to retrieve notification information; and
transmitting the notification to one or more target devices according to stored query-transmission parameters.

20. A physical data-storage device that stores computer instructions that, when executed by processors within a distributed computer system having multiple computer systems, communications networks, and data-storage devices and providing computational environments for a distributed application, control, control the distributed computer system to:
generate and store, within a notification system, an ontology that provides a mapping between a vocabulary that represents the distributed application and distributed-application-component-specific vocabularies;
use the ontology to provide a web-browser-accessible customization interface through which notifications are specified by specifying one or more of
notification information to be included in the notifications,
device or devices to which notifications are to be transmitted, and
time ranges or relative-time ranges for notification delivery;
providing a web-browser-accessible notification dashboard through which users receive, view, and store and through which users access stored notifications;
periodically monitor distributed-application components to obtain new information for updating the ontology; and
periodically monitor notification schedules to determine when to transmit notifications to target devices on which the notification dashboard is displayed.
